(19) United States
(12) Patent Application Publication
(10) Pub. No.: US 2016/0338136 A1
(43) Pub. Date: Nov. 17, 2016

(54) Method and Device for Processing Radio Link Failure

(71) Applicant: Huawei Technologies Co., Ltd., Shenzhen (CN)

(72) Inventors: Tao Zhang, Beijing (CN); Yongqiang Gao, Beijing (CN); Bo Lin, Beijing (CN)

(21) Appl. No.: 15/224,227

(22) Filed: Jul. 29, 2016

Related U.S. Application Data
(63) Continuation of application No. PCT/CN2014/071768, filed on Jan. 29, 2014.

(51) Int. Cl. H04W 76/02; H04W 36/30; H04W 74/08

(52) U.S. Cl. CPC H04W 76/028; H04W 74/0833; H04W 36/30

(57) ABSTRACT

A method, performed by a user equipment, may include: detecting whether a failure occurs on a radio link established between the user equipment and a second network device; and sending a first message to a first network device in response to a detection that a failure occurs on the radio link established between the user equipment and the second network device. The first message is used for indicating that a failure occurs on the radio link established between the user equipment and the second network device.

### CROSS-REFERENCE TO RELATED APPLICATIONS

This application is a continuation of International Application No. PCT/CN2014/071768, filed on Jan. 29, 2014, which is hereby incorporated by reference in its entirety.

### TECHNICAL FIELD

The present disclosure relates to the field of wireless communications, and in particular embodiments, to a method and a device for processing a radio link failure.

### BACKGROUND

With the development of communications technologies, a kind of network deployment has gradually been introduced in next generation wireless networks. As shown in FIG. 1, this kind of network deployment includes two kinds of base stations, namely, a master base station no and a secondary base station 120. User equipment (UE) may establish radio links to one master base station and one or more secondary base stations synchronously. For example, the UE may establish radio links to multiple cells of the master base station synchronously, and establish radio links to multiple cells of each secondary base station synchronously. The multiple cells of the master base station that establish the radio links to the UE belong to a master cell group (MCG), and the multiple cells of each secondary base station that establish the radio links to the UE belong to one secondary cell group (SCG). That is, the UE may establish radio links to one MCG and multiple SCGs synchronously.

Currently, when detecting a radio link failure, UE uses a reestablishment process shown in FIG. 2 to recover from the radio link failure. As shown in FIG. 2, the reestablishment process includes the following.

S210: The UE sends a reestablishment request message to a master base station.

S220: The master base station sends a reestablishment message to the UE, where the message may include a signaling radio bearer (SRB) related configuration and a next hop chaining count (NCC), so that the UE reestablishes an SRB according to the SRB related configuration and derives a new security key according to the NCC.

S220: The UE sends a reestablishment complete message to the master base station, where the message is sent by using the reestablished SRB and the new security key.

In the foregoing process, an SRB between the UE and the master base station is reestablished, and security between the UE and the master base station is reactivated. However, when a failure occurs on a radio link between the UE and a secondary base station but no failure occurs on a radio link between the UE and the master base station, the reestablishment of the SRB and the reactivation of the security between the UE and the master base station actually extend a time of user data interruption caused by a radio link failure, which degrades user experience for a user. It can be seen that, an existing method for processing a radio link failure is not effective and is not helpful for improving user experience.

### SUMMARY

Embodiments provide a method and a device for processing a radio link failure, so as to provide an effective solution when a radio link failure occurs between UE and a secondary base station. The technical solutions are as follows.

According to a first aspect, a method for processing a radio link failure is provided, where the method includes: detecting, by user equipment, whether a failure occurs on a radio link established between the user equipment and a second network device; and sending, by the user equipment, a first message to a first network device when it is detected that a failure occurs on the radio link established between the user equipment and the second network device, where the first message is used for indicating that a failure occurs on the radio link established between the user equipment and the second network device.

With reference to the first aspect, in a first possible implementation manner of the first aspect, the detecting, by user equipment, whether a failure occurs on a radio link established between the user equipment and a second network device includes determining that a failure occurs on the radio link established between the user equipment and the second network device, where the first radio link is any radio link established between the user equipment and the second network device when it is detected that a quantity of random access request retransmissions by the user equipment over a first radio link reaches or exceeds a maximum quantity of random access preamble retransmissions, Or, when it is detected that a timer corresponding to a first cell reaches or exceeds duration of the timer, determining that a failure occurs on the radio link established between the user equipment and the second network device, where the first cell is any cell of the second network device. Or, when it is detected that a quantity of radio link control (RLC) uplink data retransmissions by the user equipment over a first radio bearer reaches or exceeds a maximum quantity of RLC uplink data retransmissions, determining that a failure occurs on the radio link established between the user equipment and the second network device, where the first radio bearer is any radio bearer over which the second network device serves the user equipment, and is borne on one or more radio links established between the user equipment and the second network device.

With reference to the first possible implementation manner of the first aspect, in a second possible implementation manner of the first aspect, before the detecting, by user equipment, whether a failure occurs on a radio link established between the user equipment and a second network device, the method further includes receiving a configuration parameter. The configuration parameter includes one or more of the following parameters: the maximum quantity of random access preamble retransmissions, the duration of the timer, and the maximum quantity of RLC uplink data retransmissions, where the configuration parameter is acquired by the first network device from the second network device and sent to the user equipment, or the configuration parameter is sent by the second network device to the user equipment.

With reference to the first aspect, the first possible implementation manner of the first aspect or the second possible implementation manner of the first aspect, in a third possible implementation manner of the first aspect, the first message carries a link failure related identifier. The link failure related identifier includes one or more of the following identifiers: an identifier of a cell corresponding to the radio link on which the failure occurs, an identifier of a secondary cell group (SCG) where a cell corresponding to the radio link on which the failure occurs belongs, an identifier of a timing advance group (TAG) where a cell corresponding to the radio link on which the failure occurs belongs, and an identifier of a bearer corresponding to the radio link on which the failure occurs.

With reference to the first aspect, the first possible implementation manner of the first aspect, the second possible implementation manner of the first aspect or the third possible implementation manner of the first aspect, in a fourth possible implementation manner of the first aspect, the first message carries a link failure cause.

With reference to the fourth possible implementation manner of the first aspect, in a fifth possible implementation manner of the first aspect, the link failure cause includes: a random access problem, a quantity of random access preamble retransmissions reaching or exceeding a maximum quantity of random access preamble retransmissions, a quantity of RLC uplink data retransmissions reaching or exceeding a maximum quantity of RLC uplink data retransmissions, expiration of a timer or a reconfiguration failure.

With reference to the first aspect, the first possible implementation manner of the first aspect, the second possible implementation manner of the first aspect, the third possible implementation manner of the first aspect, the fourth possible implementation of the first aspect or the fifth possible implementation manner of the first aspect, in a sixth possible implementation manner of the first aspect, after the sending, by the user equipment, a first message to a first network device, the method further includes: receiving an instruction message sent by the first network device, where the instruction message is used for instructing the user equipment to release a cell, a secondary cell group (SCG), a timing advance group (TAG), or a bearer; and releasing a cell, an SCG, a TAG, or a bearer according to the instruction message.

With reference to the sixth possible implementation manner of the first aspect, in a seventh possible implementation manner of the first aspect, the releasing a cell, an SCG, a TAG, or a bearer according to the instruction message includes releasing an SCG corresponding to the second network device when the instruction message does not carry a release identifier. Or, when the instruction message carries a release identifier, releasing a cell, an SCG, a TAG, or a bearer according to the release identifier.

With reference to the seventh possible implementation manner of the first aspect, in an eighth possible implementation manner of the first aspect, the releasing a cell, an SCG, a TAG, or a bearer according to the release identifier includes releasing the cell when the release identifier is an identifier of a cell and the cell is a secondary cell in an SCG. Or, when the release identifier is an identifier of a cell and the cell is a primary cell in an SCG, or when the release identifier is an identifier of an SCG, or when the release identifier is identifiers of all cells included in an SCG, releasing the SCG. Or, when the release identifier is an identifier of a TAG, releasing the TAG. Or, when the release identifier is an identifier of a cell in a TAG, releasing a cell that is in the TAG and is controlled by the second network device. Or, when the release identifier is an identifier of a bearer served by an SCG, releasing the bearer served by the SCG.

According to a second aspect, a method for processing a radio link failure is provided, where the method includes detecting, by a second network device, whether a failure occurs on a radio link established between user equipment and the second network device; and transferring, by the second network device, a first message to a first network device when it is detected that a failure occurs on the radio link established between the user equipment and the second network device, where the first message is used for indicating that a failure occurs on the radio link established between the user equipment and the second network device.

With reference to the second aspect, in a first possible implementation manner of the second aspect, the detecting, by a second network device, whether a failure occurs on a radio link established between user equipment and the second network device includes determining that a failure occurs on the radio link established between the user equipment and the second network device when it is detected that a quantity of times of attempting to receive, by the second network device over a first radio link, a random access request sent by the user equipment reaches or exceeds a maximum quantity of times of attempting to receive a random access request, where the first radio link is any radio link established between the user equipment and the second network device. Or, when it is detected that sending physical downlink control channel (PDCCH) information by the second network device to the user equipment over a first radio link reaches or exceeds a maximum quantity of PDCCH retransmissions, determining that a failure occurs on the radio link established between the user equipment and the second network device, where the first radio link is any radio link established between the user equipment and the second network device. Or, when it is detected that a quantity of radio link control (RLC) downlink data retransmissions by the second network device over a first radio bearer reaches or exceeds a maximum quantity of RLC downlink data retransmissions, determining that a failure occurs on the radio link established between the user equipment and the second network device, where the first radio bearer is any radio bearer over which the second network device serves the user equipment, and is borne on one or more radio links established between the user equipment and the second network device. Or, when it is detected that a block error rate of uplink data that is sent by the user equipment and received over a first radio link by the second network device is greater than or equal to a preset block error rate, determining that a failure occurs on the radio link established between the user equipment and the second network device, where the first radio link is any radio link established between the user equipment and the second network device. Or, when it is detected that a bit error rate of uplink data that is sent by the user equipment and received over a first radio link by the second network device is greater than or equal to a preset bit error rate, determining that a failure occurs on the radio link established between the user equipment and the second network device, where the first radio link is any radio link established between the user equipment and the second network device.

With reference to the first possible implementation manner of the second aspect, in a second possible implementation manner of the second aspect, before the detecting, by a second network device, whether a failure occurs on a radio link established between user equipment and the second network device, the method further includes receiving a configuration parameter sent by the first network device. The configuration parameter includes one or more of the following parameters: the maximum quantity of times of attempting to receive a random access request, the maximum quantity of PDCCH retransmissions, the maximum quantity of RLC downlink data retransmissions, the preset block error rate, and the preset bit error rate.

With reference to the second aspect, the first possible implementation manner of the second aspect or the second possible implementation manner of the second aspect, in a third possible implementation manner of the second aspect, the first message carries an identifier of the user equipment and a link failure related identifier. The link failure related identifier includes one or more of the following identifiers: an identifier of a cell corresponding to the radio link on which the failure occurs, an identifier of a secondary cell group (SCG) where a cell corresponding to the radio link on which the failure occurs belongs, an identifier of a timing advance group (TAG) where a cell corresponding to the radio link on which the failure occurs belongs, and an identifier of a bearer corresponding to the radio link on which the failure occurs.

With reference to the second aspect, the first possible implementation manner of the second aspect, the second possible implementation manner of the second aspect or the third possible implementation manner of the second aspect, in a fourth possible implementation manner of the second aspect, the first message carries a link failure cause.

With reference to the fourth possible implementation manner of the second aspect, in a fifth possible implementation manner of the second aspect, the link failure cause includes: a random access problem, a quantity of times of receiving a random access request reaching or exceeding a maximum quantity of times of attempting to receive a random access request, a quantity of PDCCH retransmissions reaching or exceeding a maximum quantity of PDCCH retransmissions, a quantity of RLC downlink data retransmissions reaching or exceeding a maximum quantity of RLC downlink data retransmissions, a block error rate of uplink data reaching or exceeding a preset block error rate, a bit error rate of uplink data reaching or exceeding a preset bit error rate, an uplink reception problem or a downlink sending problem.

With reference to the second aspect, the first possible implementation manner of the second aspect, the second possible implementation manner of the second aspect, the third possible implementation manner of the second aspect, the fourth possible implementation manner of the second aspect or the fifth possible implementation manner of the second aspect, in a sixth possible implementation manner of the second aspect, after the sending, by the second network device, a first message to a first network device, the method further includes receiving an instruction message sent by the first network device, where the instruction message is used for instructing the second network device to release a resource used for serving the user equipment; and releasing, according to the instruction message, a resource used for serving the user equipment.

With reference to the sixth possible implementation manner of the second aspect, in a seventh possible implementation manner of the second aspect, the releasing, according to the instruction message, a resource used for serving the user equipment includes releasing a resource used for serving the user equipment when the instruction message includes an identifier of the user equipment. Or, when the instruction message includes an identifier of the user equipment and an identifier of a cell, releasing a resource, of the cell, used for serving the user equipment. Or, when the instruction message includes an identifier of the user equipment and an identifier of a TAG, releasing a resource, of the TAG, used for serving the user equipment. Or, when the instruction message includes an identifier of the user equipment and an identifier of a cell in a TAG, releasing a resource, of a cell included in the TAG and controlled by the second network device, used for serving the user equipment. Or, when the instruction message includes an identifier of the user equipment and an identifier of a bearer, releasing a resource used for serving the bearer of the user equipment.

According to a third aspect, a method for processing a radio link failure is provided, where the method includes receiving, by a first network device, a first message, where the first message is reported to the first network device by user equipment or a second network device when a failure occurs on a radio link established between the user equipment and the second network device. The method further includes determining, by the first network device according to the first message, that a failure occurs on the radio link established between the user equipment and the second network device.

With reference to the third aspect, in a first possible implementation manner of the third aspect, the first message carries a link failure related identifier, and the link failure related identifier includes one or more of the following identifiers: an identifier of a cell corresponding to the radio link on which the failure occurs, an identifier of a secondary cell group (SCG) where a cell corresponding to the radio link on which the failure occurs belongs, an identifier of a timing advance group (TAG) where a cell corresponding to the radio link on which the failure occurs belongs, and an identifier of a bearer corresponding to the radio link on which the failure occurs.

With reference to the first possible implementation manner of the third aspect, in a second possible implementation manner of the third aspect, the first message further carries an identifier of the user equipment.

With reference to the third aspect, the first possible implementation manner of the third aspect or the second possible implementation manner of the third aspect, in a third possible implementation manner of the third aspect, the first message carries a link failure cause.

With reference to the third possible implementation manner of the third aspect, in a fourth possible implementation manner of the third aspect, the link failure cause includes: a random access problem, a quantity of random access preamble retransmissions reaching or exceeding a maximum quantity of random access preamble retransmissions, a quantity of RLC uplink data retransmissions reaching or exceeding a maximum quantity of RLC uplink data retransmissions, expiration of a timer, a reconfiguration failure, a quantity of times of receiving a random access request reaching or exceeding a maximum quantity of times of attempting to receive a random access request, a quantity of PDCCH retransmissions reaching or exceeding a maximum quantity of PDCCH retransmissions, a quantity of RLC downlink data retransmissions reaching or exceeding a maximum quantity of RLC downlink data retransmissions, a block error rate of uplink data reaching or exceeding a preset block error rate, a bit error rate of uplink data reaching or exceeding a preset bit error rate, an uplink reception problem or a downlink sending problem.

With reference to the third aspect, the first possible implementation manner of the third aspect, the second possible implementation manner of the third aspect, the third possible implementation manner of the third aspect or the fourth possible implementation manner of the third aspect, in a fifth possible implementation manner of the third aspect, after the determining, by the first network device according to the first message, that a failure occurs on the radio link established between the user equipment and the second network device, the method further includes: sending a second message to the user equipment according to the first message, where the second message is used for instructing the user equipment to release a cell, a secondary cell group (SCG), a timing advance group (TAG) or a bearer; and/or, sending a third message to the second network device according to the first message, where the third message is used for instructing the second network device to release a resource used for serving the user equipment.

With reference to the fifth possible implementation manner of the third aspect, in a sixth possible implementation manner of the third aspect, the sending a second message to the user equipment according to the first message includes determining an identifier of a SCG where a cell corresponding to the radio link on which the failure occurs belongs, an identifier of a cell included in the SCG, an identifier of a primary cell included in the SCG, or an identifier of a bearer served by the SCG as a first release identifier in response to the first message not carrying a link failure related identifier. Or, if the first message carries a link failure related identifier, determining a first release identifier according to the link failure related identifier. The sending a second message to the user equipment according to the first message also includes sending the second message to the user equipment, where the second message carries the first release identifier.

With reference to the sixth possible implementation manner of the third aspect, in a seventh possible implementation manner of the third aspect, the determining a first release identifier according to the link failure related identifier includes determining the identifier of the cell as the first release identifier when the link failure related identifier includes an identifier of a cell corresponding to the radio link on which the failure occurs. Or, when the link failure related identifier includes an identifier of an SCG where a cell corresponding to the radio link on which the failure occurs belongs, determining the identifier of the SCG, an identifier of a cell included in the SCG, an identifier of a primary cell included in the SCG, or an identifier of a bearer served by the SCG as the first release identifier. Or, when the link failure related identifier includes an identifier of a TAG where a cell corresponding to the radio link on which the failure occurs belongs, determining the identifier of the TAG or an identifier of a cell included in the TAG as the first release identifier. Or, when the link failure related identifier includes an identifier of a bearer corresponding to the radio link on which the failure occurs, determining an identifier of an SCG serving the bearer, an identifier of a cell included in the SCG, an identifier of a primary cell included in the SCG, or an identifier of a bearer served by the SCG as the first release identifier.

With reference to the fifth possible implementation manner of the third aspect, in an eighth possible implementation manner of the third aspect, the sending a third message to the second network device according to the first message includes determining an identifier of the user equipment as a second release identifier if the first message does not carry a link failure related identifier. Or, if the first message carries a link failure related identifier, determining a second release identifier according to the link failure related identifier. The sending a third message to the second network device according to the first message also includes sending the third message to the second network device, where the third message carries the second release identifier.

With reference to the eighth possible implementation manner of the third aspect, in a ninth possible implementation manner of the third aspect, the determining a second release identifier according to the link failure related identifier includes determining an identifier of the user equipment and the identifier of the cell as the second release identifier when the link failure related identifier includes an identifier of a cell corresponding to the radio link on which the failure occurs. Or, when the link failure related identifier includes an identifier of an SCG where a cell corresponding to the radio link on which the failure occurs belongs, determining an identifier of the user equipment as the second release identifier. Or, when the link failure related identifier includes an identifier of a TAG where a cell corresponding to the radio link on which the failure occurs belongs, determining an identifier of the user equipment and the identifier of the TAG as the second release identifier, or determining an identifier of the user equipment and an identifier of a cell included in the TAG as the second release identifier. Or, when the link failure related identifier includes an identifier of a bearer corresponding to the radio link on which the failure occurs, determining an identifier of the user equipment as the second release identifier, or determining an identifier of the user equipment and an identifier of a bearer served by an SCG serving the bearer as the second release identifier.

With reference to the third aspect or any one possible implementation manner of the first possible implementation manner of the third aspect to the ninth possible implementation manner of the third aspect, in a tenth possible implementation manner of the third aspect, before the receiving a first message, the method further includes at least one of the following. Sending a first configuration parameter to the user equipment, where the first configuration parameter includes one or more of the following parameters: a maximum quantity of random access preamble retransmissions, duration of a timer, and a maximum quantity of radio link control (RLC) uplink data retransmissions; or sending a second configuration parameter to the second network device, where the second configuration parameter includes one or more of the following parameters: a maximum quantity of times of attempting to receive a random access request, a maximum quantity of physical downlink control channel (PDCCH) retransmissions, a maximum quantity of RLC downlink data retransmissions, a preset block error rate, and a preset bit error rate.

According to a fourth aspect, a device for processing a radio link failure is provided and is located on a user equipment side, where the device includes a detecting unit, configured to detect whether a failure occurs on a radio link established between user equipment and a second network device; and a sending unit, configured to send a first message to a first network device when the detecting unit detects that a failure occurs on the radio link established between the user equipment and the second network device, where the first message is used for indicating that a failure occurs on the radio link established between the user equipment and the second network device.

With reference to the fourth aspect, in a first possible implementation manner of the fourth aspect, the detecting unit is configured to determine that a failure occurs on the radio link established between the user equipment and the second network device when it is detected that a quantity of random access request retransmissions by the user equipment over a first radio link reaches or exceeds a maximum quantity of random access preamble retransmissions, where the first radio link is any radio link established between the user equipment and the second network device. Or, when it is detected that a timer corresponding to a first cell reaches or exceeds duration of the timer, determine that a failure occurs on the radio link established between the user equipment and the second network device, where the first cell is any cell of the second network device. Or, when it is detected that a quantity of radio link control (RLC) uplink data retransmissions by the user equipment over a first radio bearer reaches or exceeds a maximum quantity of RLC uplink data retransmissions, determine that a failure occurs on the radio link established between the user equipment and the second network device, where the first radio bearer is any radio bearer over which the second network device serves the user equipment, and is borne on one or more radio links established between the user equipment and the second network device.

With reference to the first possible implementation manner of the fourth aspect, in a second possible implementation manner of the fourth aspect, the device further includes a receiving unit, configured to receive a configuration parameter. The configuration parameter includes one or more of the following parameters: the maximum quantity of random access preamble retransmissions, the duration of the timer, and the maximum quantity of RLC uplink data retransmissions, where the configuration parameter is acquired by the first network device from the second network device and sent to the user equipment, or the configuration parameter is sent by the second network device to the user equipment.

With reference to the fourth aspect, the first possible implementation manner of the fourth aspect or the second possible implementation manner of the fourth aspect, in a third possible implementation manner of the fourth aspect, the first message carries a link failure related identifier, and the link failure related identifier includes one or more of the following identifiers: an identifier of a cell corresponding to the radio link on which the failure occurs, an identifier of a secondary cell group (SCG) where a cell corresponding to the radio link on which the failure occurs belongs, an identifier of a timing advance group (TAG) where a cell corresponding to the radio link on which the failure occurs belongs, and an identifier of a bearer corresponding to the radio link on which the failure occurs.

With reference to the fourth aspect, the first possible implementation manner of the fourth aspect, the second possible implementation manner of the fourth aspect or the third possible implementation manner of the fourth aspect, in a fourth possible implementation manner of the fourth aspect, the first message carries a link failure cause.

With reference to the fourth possible implementation manner of the fourth aspect, in a fifth possible implementation manner of the fourth aspect, the link failure cause includes: a random access problem, a quantity of random access preamble retransmissions reaching or exceeding a maximum quantity of random access preamble retransmissions, a quantity of RLC uplink data retransmissions reaching or exceeding a maximum quantity of RLC uplink data retransmissions, expiration of a timer, or a reconfiguration failure.

With reference to the fourth aspect, the first possible implementation manner of the fourth aspect, the second possible implementation manner of the fourth aspect, the third possible implementation manner of the fourth aspect, the fourth possible implementation of the fourth aspect or the fifth possible implementation manner of the fourth aspect, in a sixth possible implementation manner of the fourth aspect, the receiving unit is further configured to receive an instruction message sent by the first network device, where the instruction message is used for instructing the user equipment to release a cell, a secondary cell group (SCG), a timing advance group (TAG) or a bearer. The device further includes a releasing unit, configured to release a cell, an SCG, a TAG or a bearer according to the instruction message.

With reference to the sixth possible implementation manner of the fourth aspect, in a seventh possible implementation manner of the fourth aspect, the releasing unit is configured to release an SCG corresponding to the second network device when the instruction message does not carry a release identifier. Or, when the instruction message carries a release identifier, release a cell, an SCG, a TAG or a bearer according to the release identifier.

With reference to the seventh possible implementation manner of the fourth aspect, in an eighth possible implementation manner of the fourth aspect, when the instruction message carries the release identifier, the releasing unit is configured to release the cell when the release identifier is an identifier of a cell and the cell is a secondary cell in an SCG. Or, when the release identifier is an identifier of a cell and the cell is a primary cell in an SCG, or when the release identifier is an identifier of an SCG, or when the release identifier is identifiers of all cells included in an SCG, release the SCG. Or, when the release identifier is an identifier of a TAG, release the TAG. Or, when the release identifier is an identifier of a cell in a TAG, release a cell that is in the TAG and is controlled by the second network device. Or, when the release identifier is an identifier of a bearer served by an SCG, release the bearer served by the SCG.

According to a fifth aspect, a device for detecting a radio link failure is provided and is located on a second network device side, where the device includes: a detecting unit, configured to detect whether a failure occurs on a radio link established between user equipment and a second network device; and an interface unit, configured to transfer a first message to a first network device when the detecting unit detects that a failure occurs on the radio link established between the user equipment and the second network device, where the first message is used for indicating that a failure occurs on the radio link established between the user equipment and the second network device.

With reference to the fifth aspect, in a first possible implementation manner of the fifth aspect, the detecting unit is configured to determine that a failure occurs on the radio link established between the user equipment and the second network device when it is detected that a quantity of times of attempting to receive, by the second network device over a first radio link, a random access request sent by the user equipment reaches or exceeds a maximum quantity of times of attempting to receive a random access request, where the first radio link is any radio link established between the user equipment and the second network device. Or, when it is detected that sending physical downlink control channel (PDCCH) information by the second network device to the user equipment over a first radio link reaches or exceeds a maximum quantity of PDCCH retransmissions, determine that a failure occurs on the radio link established between the user equipment and the second network device, where the first radio link is any radio link established between the user equipment and the second network device. Or, when it is detected that a quantity of radio link control (RLC) downlink data retransmissions by the second network device over a first radio bearer reaches or exceeds a maximum quantity of RLC downlink data retransmissions, determine that a failure occurs on the radio link established between the user equipment and the second network device, where the first radio bearer is any radio bearer over which the second network device serves the user equipment, and is borne on one or more radio links established between the user equipment and the second network device. Or, when it is detected that a block error rate of uplink data that is sent by the user equipment and received over a first radio link by the second network device is greater than or equal to a preset block error rate, determine that a failure occurs on the radio link established between the user equipment and the second network device, where the first radio link is any radio link established between the user equipment and the second network device. Or, when it is detected that a bit error rate of uplink data that is sent by the user equipment and received over a first radio link by the second network device is greater than or equal to a preset bit error rate, determine that a failure occurs on the radio link established between the user equipment and the second network device, where the first radio link is any radio link established between the user equipment and the second network device.

With reference to the first possible implementation manner of the fifth aspect, in a second possible implementation manner of the fifth aspect, the interface unit is further configured to receive a configuration parameter sent by the first network device. The configuration parameter includes one or more of the following parameters: the maximum quantity of times of attempting to receive a random access request, the maximum quantity of PDCCH retransmissions, the maximum quantity of RLC downlink data retransmissions, the preset block error rate, and the preset bit error rate.

With reference to the fifth aspect, the first possible implementation manner of the fifth aspect or the second possible implementation manner of the fifth aspect, in a third possible implementation manner of the fifth aspect, the first message carries an identifier of the user equipment and a link failure related identifier. The link failure related identifier includes one or more of the following identifiers: an identifier of a cell corresponding to the radio link on which the failure occurs, an identifier of a secondary cell group (SCG) where a cell corresponding to the radio link on which the failure occurs belongs, an identifier of a timing advance group (TAG) where a cell corresponding to the radio link on which the failure occurs belongs, and an identifier of a bearer corresponding to the radio link on which the failure occurs.

With reference to the fifth aspect, the first possible implementation manner of the fifth aspect, the second possible implementation manner of the fifth aspect or the third possible implementation manner of the fifth aspect, in a fourth possible implementation manner of the fifth aspect, the first message carries a link failure cause.

With reference to the fourth possible implementation manner of the fifth aspect, in a fifth possible implementation manner of the fifth aspect, the link failure cause includes: a random access problem, a quantity of times of receiving a random access request reaching or exceeding a maximum quantity of times of attempting to receive a random access request, a quantity of PDCCH retransmissions reaching or exceeding a maximum quantity of PDCCH retransmissions, a quantity of RLC downlink data retransmissions reaching or exceeding a maximum quantity of RLC downlink data retransmissions, a block error rate of uplink data reaching or exceeding a preset block error rate, a bit error rate of uplink data reaching or exceeding a preset bit error rate, an uplink reception problem or a downlink sending problem.

With reference to the fifth aspect, the first possible implementation manner of the fifth aspect, the second possible implementation manner of the fifth aspect, the third possible implementation manner of the fifth aspect, the fourth possible implementation manner of the fifth aspect or the fifth possible implementation manner of the fifth aspect, in a sixth possible implementation manner of the fifth aspect, the interface unit is further configured to receive an instruction message sent by the first network device, where the instruction message is used for instructing the second network device to release a resource used for serving the user equipment, and the device further includes a releasing unit, configured to release, according to the instruction message, a resource used for serving the user equipment.

With reference to the sixth possible implementation manner of the fifth aspect, in a seventh possible implementation manner of the fifth aspect, the releasing unit is configured to release a resource used for serving the user equipment when the instruction message includes an identifier of the user equipment, or when the instruction message includes an identifier of the user equipment and an identifier of a cell, release a resource, of the cell, used for serving the user equipment. Or, when the instruction message includes an identifier of the user equipment and an identifier of a TAG, release a resource, of the TAG, used for serving the user equipment. Or, when the instruction message includes an identifier of the user equipment and an identifier of a cell included in a TAG, release a resource, of a cell included in the TAG and controlled by the second network device, used for serving the user equipment. Or, when the instruction message includes an identifier of the user equipment and an identifier of a bearer, release a resource used for serving the bearer of the user equipment.

According to a sixth aspect, a device for processing a radio link failure is provided and is located on a first network device side, where the device includes a transceiver unit, configured to communicate with user equipment; an interface unit, configured to communicate with a second network device; an acquiring unit, configured to acquire a first message from the user equipment or the second network device through the transceiver unit or the interface unit, where the first message is reported to a first network device by the user equipment or the second network device when a failure occurs on a radio link established between the user equipment and the second network device; and a determining unit, configured to determine, according to the first message, that a failure occurs on the radio link established between the user equipment and the second network device.

With reference to the sixth aspect, in a first possible implementation manner of the sixth aspect, the first message carries a link failure related identifier. The link failure related identifier includes one or more of the following identifiers: an identifier of a cell corresponding to the radio link on which the failure occurs, an identifier of a secondary cell group (SCG) where a cell corresponding to the radio link on which the failure occurs belongs, an identifier of a timing advance group (TAG) where a cell corresponding to the radio link on which the failure occurs belongs, and an identifier of a bearer corresponding to the radio link on which the failure occurs.

With reference to the first possible implementation manner of the sixth aspect, in a second possible implementation manner of the sixth aspect, the first message further carries an identifier of the user equipment.

With reference to the sixth aspect, the first possible implementation manner of the sixth aspect or the second possible implementation manner of the sixth aspect, in a third possible implementation manner of the sixth aspect, the first message carries a link failure cause.

With reference to the third possible implementation manner of the sixth aspect, in a fourth possible implementation manner of the sixth aspect, the link failure cause includes: a random access problem, a quantity of random access preamble retransmissions reaching or exceeding a maximum quantity of random access preamble retransmissions, a quantity of RLC uplink data retransmissions reaching or exceeding a maximum quantity of RLC uplink data retransmissions, expiration of a timer, a reconfiguration failure, a quantity of times of receiving a random access request reaching or exceeding a maximum quantity of times of attempting to receive a random access request, a quantity of PDCCH retransmissions reaching or exceeding a maximum quantity of PDCCH retransmissions, a quantity of RLC downlink data retransmissions reaching or exceeding a maximum quantity of RLC downlink data retransmissions, a block error rate of uplink data reaching or exceeding a preset block error rate, a bit error rate of uplink data reaching or exceeding a preset bit error rate, an uplink reception problem or a downlink sending problem.

With reference to the sixth aspect, the first possible implementation manner of the sixth aspect, the second possible implementation manner of the sixth aspect, the third possible implementation manner of the sixth aspect or the fourth possible implementation manner of the sixth aspect, in a fifth possible implementation manner of the sixth aspect, after the determining unit determines that a failure occurs on the radio link established between the user equipment and the second network device, the determining unit is further configured to trigger the transceiver unit to send a second message to the user equipment, where the second message is used for instructing the user equipment to release a cell, a secondary cell group (SCG), a timing advance group (TAG) or a bearer; and/or trigger the interface unit to send a third message to the second network device, where the third message is used for instructing the second network device to release a resource used for serving the user equipment.

With reference to the fifth possible implementation manner of the sixth aspect, in a sixth possible implementation manner of the sixth aspect, the determining unit is further configured to trigger the transceiver unit to send, to the user equipment, the second message carrying a first release identifier. When the first message does not carry a link failure related identifier, the first release identifier includes an identifier of an SCG where a cell corresponding to the radio link on which the failure occurs belongs, an identifier of a cell included in the SCG, an identifier of a primary cell included in the SCG, or an identifier of a bearer served by the SCG. Or, when the first message carries the link failure related identifier, the first release identifier is determined according to the link failure related identifier.

With reference to the sixth possible implementation manner of the sixth aspect, in a seventh possible implementation manner of the sixth aspect, when the first message carries the link failure related identifier the first release identifier includes the identifier of the cell when the link failure related identifier includes an identifier of a cell corresponding to the radio link on which the failure occurs. Or, when the link failure related identifier includes an identifier of an SCG where a cell corresponding to the radio link on which the failure occurs belongs, the first release identifier includes the identifier of the SCG, an identifier of a cell included in the SCG, an identifier of a primary cell included in the SCG, or an identifier of a bearer served by the SCG. Or, when the link failure related identifier includes an identifier of a TAG where a cell corresponding to the radio link on which the failure occurs belongs, the first release identifier includes the identifier of the TAG or an identifier of a cell included in the TAG. Or, when the link failure related identifier includes an identifier of a bearer corresponding to the radio link on which the failure occurs, the first release identifier includes an identifier of an SCG serving the bearer, an identifier of a cell included in the SCG, an identifier of a primary cell included in the SCG, or an identifier of a bearer served by the SCG.

With reference to the fifth possible implementation manner of the sixth aspect, in an eighth possible implementation manner of the sixth aspect, the determining unit is further configured to trigger the interface unit to send, to the second network device, the third message carrying a second release identifier. When the first message does not carry a link failure related identifier, the second release identifier includes an identifier of the user equipment. Or, when the first message carries a link failure related identifier, the second release identifier is determined according to the link failure related identifier.

With reference to the eighth possible implementation manner of the sixth aspect, in a ninth possible implementation manner of the sixth aspect, when the first message carries the link failure related identifier the second release identifier includes an identifier of the user equipment and the identifier of the cell when the link failure related identifier includes an identifier of a cell corresponding to the radio link on which the failure occurs. Or, when the link failure related identifier includes an identifier of an SCG where a cell corresponding to the radio link on which the failure occurs belongs, the second release identifier includes an identifier of the user equipment. Or, when the link failure related identifier includes an identifier of a TAG where a cell corresponding to the radio link on which the failure occurs belongs, the second release identifier includes an identifier of the user equipment and the identifier of the TAG, or includes an identifier of the user equipment and an identifier of a cell included in the TAG. Or, when the link failure related identifier includes an identifier of a bearer corresponding to the radio link on which the failure occurs, the second release identifier includes an identifier of the user equipment, or includes an identifier of the user equipment and an identifier of a bearer served by an SCG serving the bearer.

With reference to the sixth aspect or any one possible implementation manner of the first possible implementation manner of the sixth aspect to the ninth possible implementation manner of the sixth aspect, in a tenth possible implementation manner of the sixth aspect, the transceiver unit is further configured to: send a first configuration parameter to the user equipment, where the first configuration parameter includes one or more of the following parameters: a maximum quantity of random access preamble retransmissions, duration of a timer, and a maximum quantity of radio link control (RLC) uplink data retransmissions; and/or send a second configuration parameter to the second network device, where the second configuration parameter includes one or more of the following parameters: a maximum quantity of times of attempting to receive a random access request, a maximum quantity of physical downlink control channel (PDCCH) retransmissions, a maximum quantity of RLC downlink data retransmissions, a preset block error rate, and a preset bit error rate.

In the embodiments, when user equipment or a secondary base station detects that a radio link failure occurs between the UE and the secondary base station, the user equipment or the secondary base station reports a message to a master base station, so as to notify the master base station that a radio link failure occurs between the UE and the secondary base station, so that the master base station learns that the radio link failure occurs between the UE and the secondary base station, and therefore unnecessary operations such as reestablishment of an SRB and reactivation of security may be no longer performed. In addition, the master base station may also perform further processing on the radio link failure, for example, release a resource related to the secondary base station and/or the UE, so that the secondary base station reallocates a resource to the UE as soon as possible, thereby effectively shortening a time of user data interruption caused by the radio link failure and improving user experience for a user.

### BRIEF DESCRIPTION OF THE DRAWINGS

To describe the technical solutions in the embodiments more clearly, the following briefly introduces the accompanying drawings required for describing the embodiments. Apparently, the accompanying drawings in the following description show merely some embodiments, and a person of ordinary skill in the art may still derive other drawings from these accompanying drawings without creative efforts.

FIG. 1 is a schematic structural diagram of network deployment in the prior art;

FIG. 2 is a flowchart of a method for processing a radio link in the prior art;

FIG. 3 is a flowchart of a method for processing a radio link failure according to Embodiment 1;

FIG. 4 is a flowchart of another method for processing a radio link failure according to Embodiment 1;

FIG. 5 is a flowchart of a method for processing a radio link failure according to Embodiment 2;

FIG. 6 is a flowchart of a method for processing a radio link failure according to Embodiment 3;

FIG. 7 is a flowchart of another method for processing a radio link failure according to Embodiment 3;

FIG. 8 is a flowchart of a method for processing a radio link failure according to Embodiment 4;

FIG. 9 is a schematic structural diagram of a device for processing a radio link failure according to Embodiment 5;

FIG. 10 is a schematic structural diagram of another device for processing a radio link failure according to Embodiment 5;

FIG. 11 is a schematic structural diagram of a device for processing a radio link failure according to Embodiment 6;

FIG. 12 is a schematic structural diagram of another device for processing a radio link failure according to Embodiment 6;

FIG. 13 is a schematic structural diagram of a device for processing a radio link failure according to Embodiment 7;

FIG. 14 is a schematic structural diagram of user equipment according to Embodiment 8;

FIG. 15 is a schematic structural diagram of a first network device according to Embodiment 9; and

FIG. 16 is a schematic structural diagram of a second network device according to Embodiment 10.

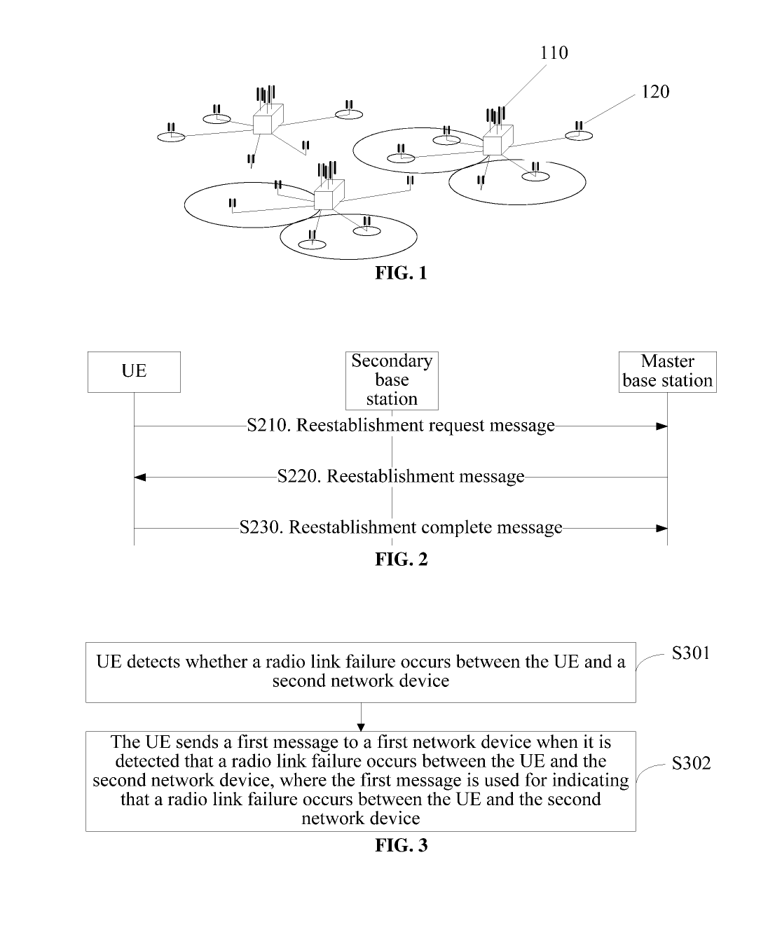

### DETAILED DESCRIPTION OF ILLUSTRATIVE EMBODIMENTS

To make the objectives, technical solutions, and advantages of the present disclosure clearer, the following describes the embodiments in further detail with reference to the accompanying drawings.

In consideration of the problem existing in the prior art, in the embodiments, when a radio link failure occurs between UE and a secondary base station, the radio link failure may be reported to a master base station, so that the master base station learns that the radio link failure occurs between the UE and the secondary base station, and therefore unnecessary operations such as reestablishment of an SRB and reactivation of security may be no longer performed, thereby effectively shortening a time of user data interruption caused by a radio link failure and improving user experience for a user. In addition, the master base station may perform further processing on the radio link failure, for example, release a resource related to the secondary base station and/or the UE, so that the secondary base station reallocates a resource to the UE as soon as possible, thereby further shortening the time of the user data interruption caused by the radio link failure and improving the user experience for the user.

The solutions and effects of the present disclosure are described in further detail in the following with reference to multiple embodiments. In the following embodiments, a network device may be a network node that can communicate with user equipment, and includes a base station (BS), a Node B, an eNB (evolved Node B), a WiFi access point, or the like.

User equipment may be a mobile communications terminal, and includes a cellular phone, a personal digital assistant (PDA), a wireless modem, a handheld device, a laptop computer, a cordless phone, or the like.

### Embodiment 1

In this embodiment, when UE detects that a radio link failure occurs between the UE and a secondary base station, the UE reports a message to a master base station, so as to notify the master base station that a radio link failure occurs between the UE and the secondary base station. Referring to FIG. 3, FIG. 3 is a flowchart of a method for processing a radio link failure according to an embodiment. As shown in FIG. 3, the method includes the following.

S301. UE detects whether a radio link failure occurs between the UE and a second network device, that is, the UE detects whether a failure occurs on a radio link established between the UE and the second network device. When radio links are established between the UE and multiple cells of the second network device, it may be set that a radio link failure occurs between the UE and the second network device (that is, a failure occurs on a radio link established between the UE and the second network device) when a failure occurs on any radio link; or it may be set that a radio link failure occurs between the UE and the second network device (that is, a failure occurs on a radio link established between the UE and the second network device) when a failure occurs on a radio link or some radio links.

S302. The UE sends a first message to a first network device when it is detected that a radio link failure occurs between the UE and the second network device, where the first message is used for indicating that a radio link failure occurs between the user equipment and the second network device. That is, the first message is sent to the first network device when it is detected that a failure occurs on the radio link established between the UE and the second network device, where the first message is used for indicating that a failure occurs on the radio link established between the user equipment and the second network device; in other words, the first message is used for indicating that a radio link failure occurs between the user equipment and the second network device.

The first network device in the foregoing refers to a master base station, and the second network device refers to a secondary base station. When the UE detects that a radio link failure occurs between the UE and the secondary base station, the UE may report the radio link failure to the master base station, so that the master base station learns that the radio link failure occurs between the UE and the secondary base station, and therefore unnecessary operations such as reestablishment of an SRB and reactivation of security may be no longer performed. In addition, the master base station may perform further processing on the radio link failure, for example, release a resource related to the secondary base station and/or the UE, so that the secondary base station reallocates a resource to the UE as soon as possible, thereby effectively shortening a time of user data interruption caused by the radio link failure and improving user experience for a user.

Step S301 in the foregoing, that is, the step in which the UE detects whether a radio link failure occurs between the UE and the second network device, may be implemented in the following manners:

In a first manner, when it is detected that a quantity of random access request retransmissions by the user equipment over a first radio link reaches or exceeds a maximum quantity of random access preamble retransmissions, it is determined that a failure occurs on the radio link established between the user equipment and the second network device, where the first radio link is any radio link established between the user equipment and the second network device.

Because the second network device may control multiple cells, the UE may establish a radio link to each of the multiple cells controlled by the second network device, that is, the UE may establish multiple radio links to the second network device. When the UE sends a random access request to the second network device over a radio link established between the UE and a cell controlled by the second network device, if the random access request fails to be sent, the UE resends the random access request to the second network device over the radio link, and counts a quantity (hereinafter referred to as a first quantity) of times of repeatedly sending the random access request to the second network device by the UE over the radio link. When the first quantity of times reaches or exceeds the maximum quantity of random access preamble retransmissions, the UE determines that a failure occurs on the radio link; otherwise, the UE determines that no failure occurs on the radio link.

In a second manner, when it is detected that a timer corresponding to a first cell reaches or exceeds duration of the timer, it is determined that a failure occurs on the radio link established between the user equipment and the second network device, where the first cell is any cell of the second network device.

Because the second network device may control multiple cells, the UE may establish a radio link to each of the multiple cells controlled by the second network device, that is, the UE may establish multiple radio links to the second network device. The UE may set timers for all or some of the cells of the second network device and may set one timer for each cell, and timers for different cells may have same duration or may have different duration. When the UE detects that downlink signal quality of a cell controlled by the second network device is less than or equal to a preset quality threshold, a corresponding timer is started. If it is detected that the downlink signal quality of the cell is not greater than the preset quality threshold within duration of the timer, that is, it is detected that the downlink signal quality of the cell keeps less than or equal to the preset quality threshold, it is determined that a failure occurs on a radio link established between the UE and the cell. If it is detected that the downlink signal quality of the cell is greater than the preset quality threshold within the timing duration of the timer, the timer is stopped, and it is determined that no failure occurs on the radio link established between the UE and the cell.

In a third manner, when it is detected that a quantity of radio link control (RLC) uplink data retransmissions by the user equipment over a first radio bearer reaches or exceeds a maximum quantity of RLC uplink data retransmissions, it is determined that a failure occurs on the radio link established between the user equipment and the second network device, where the first radio bearer is any radio bearer over which the second network device serves the user equipment, and is borne on one or more radio links established between the user equipment and the second network device.

Because the second network device may control multiple cells, the UE may establish a radio link to each of the multiple cells controlled by the second network device, that is, the UE may establish multiple radio links to the second network device. When the UE sends RLC uplink data to the second network device over a radio bearer (RB) established between the UE and the second network device, if the RLC uplink data fails to be sent, the user equipment resends the RLC uplink data to the second network device over the RB, and counts a quantity (hereinafter referred to as a second quantity) of times of repeatedly sending the RLC uplink data to the second network device by the UE over the RB. When the second quantity of times reaches or exceeds the maximum quantity of RLC uplink data retransmissions, it is determined that a failure occurs on a radio link, bearing the RB, between the UE and the second network device; otherwise, it is determined that no failure occurs on the radio link, bearing the RB, between the UE and the second network device.

It should be noted that the maximum quantity of random access preamble retransmissions, the duration of the timer, and the maximum quantity of RLC uplink data retransmissions in the foregoing may be acquired by the first network device from the second network device and sent to the UE, or may be directly sent by the second network device to the UE, which is described in detail in Embodiment 2 in the following, and is not elaborated herein.

It should be noted that the first message in the foregoing may be a newly added message, in other words, a dedicatedly set message; when the master base station receives the message, it may be learned, according to the name of the message, that a radio link failure occurs between the UE and the secondary base station. In addition, the first message may also be an information element newly added in an existing message, or, a dedicatedly set information element; when the master base station receives the first message, it may be learned, according to whether the newly added information element is included in the first message, whether a radio link failure occurs between the UE and the secondary base station.

Optionally, the first message may carry a link failure related identifier, and the link failure related identifier may include one or more of the following identifiers: an identifier of a cell corresponding to the radio link on which the failure occurs, an identifier of a secondary cell group (SCG) where a cell corresponding to the radio link on which the failure occurs belongs, an identifier of a timing advance group (TAG) where a cell corresponding to the radio link on which the failure occurs belongs, and an identifier of a bearer corresponding to the radio link on which the failure occurs.

In this way, the master base station may determine, according to the link failure related identifier, to release a resource related to the secondary base station and/or the UE, so that the secondary base station reallocates a resource to the UE as soon as possible, thereby further shortening a time of user data interruption caused by the radio link failure and improving user experience for a user, which is described in detail in Embodiment 2 and is not elaborated herein.

Certainly, the first message may not carry the link failure related identifier; in such a case, when a radio link failure occurs between the secondary base station and the UE, the master base station may avoid unnecessary operations such as reestablishment of an SRB and reactivation of security according to the first message, and does not perform further processing. In addition, if only one secondary base station provides a service for the UE, a resource related to the secondary base station and/or the UE may also be released according to the first message.

Optionally, the first message may carry a link failure cause. Certainly, the first message may carry only the link failure related identifier or the link failure cause, or may carry both the link failure related identifier and the link failure cause. When the first message carries the link failure cause, the master base station may locate a failure cause more accurately, and therefore, can recover from a failure at a minimum cost.

The link failure cause in the foregoing may include: a random access problem, a quantity of random access preamble retransmissions reaching a maximum quantity of random access preamble retransmissions, a quantity of RLC uplink data retransmissions reaching a maximum quantity of RLC uplink data retransmissions, expiration of a timer, or a reconfiguration failure.

Further, the master base station may instruct the secondary base station and/or the UE to release a related resource after determining, according to the first message, that a failure occurs on the radio link established between the UE and the secondary base station, so that the secondary base station reallocates a resource to the UE as soon as possible, thereby shortening a time of user data interruption caused by the radio link failure and improving user experience for a user.

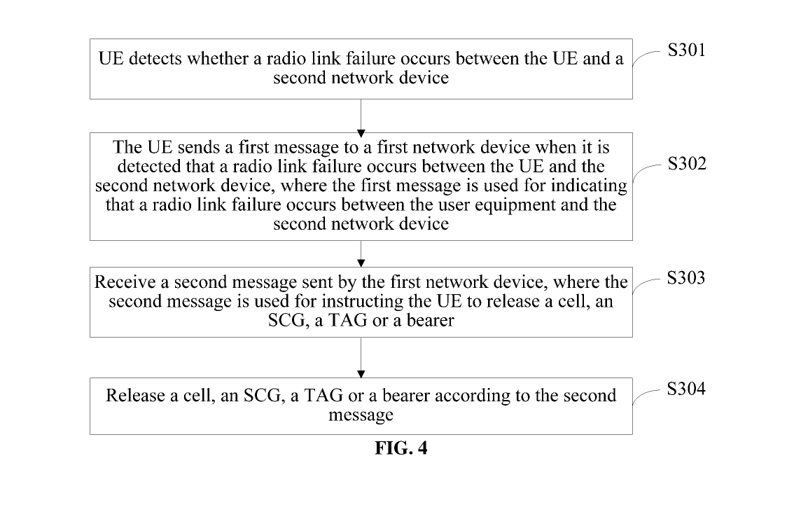

For example, as shown in FIG. 4, after step S302 in the foregoing, the master base station sends a second message to the UE according to the first message, where the second message is used for instructing the user equipment to release a cell, an SCG, a timing advance group (TAG) or a bearer. In this case, the foregoing method for processing a radio link failure may further include the following.

S303. Receive a second message sent by the first network device, where the second message is used for instructing the UE to release a cell, an SCG, a TAG or a bearer.

S304. Release a cell, an SCG, a TAG or a bearer according to the second message.

Specifically, in step S304 in the foregoing, when the second message does not carry a release identifier, it may be considered that none of radio links established between the UE and the second network device can be normally used, and the UE may release an SCG corresponding to the second network device. The operation that the UE releases the SCG corresponding to the second network device may include a first case to a third case as follows.

In a first case, release an RB served by the SCG. If one RB is only served by the SCG, release the RB, that is, release a Packet Data Convergence Protocol (PDCP) entity, an RLC entity, and a logic channel that are related to the RB; if one RB is served by both an MCG and the SCG, release a part, which is served by the SCG, of the RB, that is, release an RLC entity and a logic channel, which correspond to the SCG, in RLC entities and logic channels that are related to the RB.

It should be noted that when one RB is served by only one SCG, one PDCP entity, one RLC entity, and one logic channel are related to the RB. The PDCP entity, the RLC entity, and the logic channel all correspond to the SCG. When one RB is served by both an MCG and an SCG, one PDCP entity, two RLC entities, and two logic channels are related to the RB, where one RLC entity and one logic channel correspond to the SCG, and the other RLC entity and the other logic channel correspond to the MCG.

In a second case, release a Media Access Control (MAC) entity corresponding to the SCG.

It should be noted that the user equipment has one MAC entity corresponding to the MCG, and further has one or more MAC entities, each of which corresponds to one SCG.

In a third case, release a cell included in the SCG.

After the UE releases the SCG corresponding to the second network device, the UE may further reestablish a radio link established between the UE and a cell included in the SCG corresponding to the second network device. Therefore, compared with the prior art, a radio link may start to be established as soon as possible, thereby further shortening a time of user data interruption caused by the radio link failure and improving user experience for a user.

Further, in step S304 in the foregoing, when the second message carries a release identifier, a cell, an SCG, a TAG or a bearer is released according to the release identifier.

For example, when the release identifier is an identifier of a cell and the cell is a secondary cell in an SCG, the cell is released; when the release identifier is an identifier of a cell and the cell is a primary cell in an SCG, or when the release identifier is an identifier of an SCG, or when the release identifier is identifiers of all cells included in an SCG, the SCG is released; when the release identifier is an identifier of a TAG, the TAG is released; when the release identifier is an identifier of a cell in a TAG, a cell included in the TAG is released; or when the release identifier is an identifier of a bearer served by an SCG, the bearer served by the SCG is released.

Cells included in one TAG may be cells controlled by one network device, or may be cells controlled by multiple network devices. Correspondingly, a specific operation of releasing the cell included in the TAG may be as follows: When cells included in the TAG are cells controlled by one network device, directly release all cells included in the TAG. When cells included in the TAG are cells controlled by multiple network devices, select a cell controlled by the second network device from the cells included in the TAG, and release the selected cell.

A specific operation of releasing the bearer served by the SCG may be as follows.

If the identifier of the bearer served by the SCG is an identifier of an RB, when the RB is served by only the SCG, release the RB, that is, release a PDCP entity, an RLC entity, and a logic channel that are related to the RB; when the RB is served by both an MCG and the SCG, release a part, which is served by the SCG, of the bearer, that is, release an RLC entity and a logic channel, which correspond to the SCG, in RLC entities and logic channels that are related to the bearer.

If the identifier of the bearer served by the SCG is an identifier of an E-UTRAN radio access bearer (E-RAB), the user equipment acquires an identifier of a corresponding RB from a stored correspondence between an identifier of an RB and an identifier of an E-RAB according to the identifier of the E-RAB. When the RB is served by only the SCG, the RB is released, that is, a PDCP entity, an RLC entity, and a logic channel that are related to the RB are released; when the RB is served by both an MCG and the SCG, a part, which is served by the SCG, of the bearer is released, that is, an RLC entity and a logic channel, which correspond to the SCG, in RLC entities and logic channels that are related to the bearer are released.

In this embodiment, when user equipment detects that a radio link failure occurs between the user equipment and a secondary base station, the user equipment reports a message to a master base station, so as to notify the master base station that a radio link failure occurs between the UE and the secondary base station, so that the master base station learns that the radio link failure occurs between the UE and the secondary base station, and therefore unnecessary operations such as reestablishment of an SRB and reactivation of security may be no longer performed. In addition, the master base station may also perform further processing on the radio link failure, for example, release a resource related to the secondary base station and/or the UE, so that the secondary base station reallocates a resource to the UE as soon as possible, thereby effectively shortening a time of user data interruption caused by the radio link failure and improving user experience for a user.

With reference to Embodiment 2 in the following, a process in which a master base station performs further processing after learning that a radio link failure occurs between UE and a secondary base station is described.

### Embodiment 2

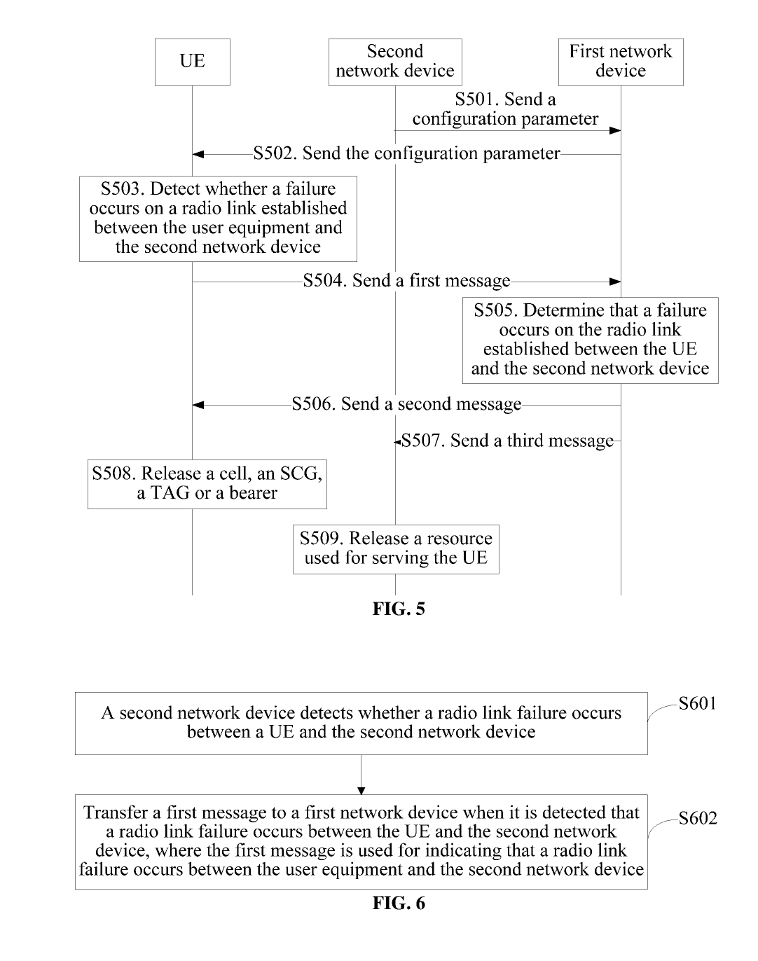

Referring to FIG. 5, FIG. 5 is a signaling flowchart of another method for processing a radio link failure according to an embodiment. A first network device is a master base station, and a second network device is a secondary base station. As shown in FIG. 5, the method includes the following.

S501. A second network device sends a configuration parameter to a first network device, where the configuration parameter includes one or more of the following parameters: a maximum quantity of random access preamble retransmissions, a maximum quantity of RLC uplink data retransmissions, and duration of a timer.

The timer may be a T310 timer.

S502. The first network device receives the configuration parameter sent by the second network device, and sends the configuration parameter to UE.

Because the first network device may generate a radio resource control (RRC) message for the UE, the foregoing configuration parameter may be transmitted by using an RRC message, which is merely an example herein, and in the embodiment, a transmission format of the message is not limited; or the configuration parameter may be transmitted by using another message process between the first network device and the second network device.

The configuration parameter sent by the first network device to the UE may carry all parameters or some of parameters in the configuration parameter sent by the second network device to the first network device, which is not limited in the embodiment.

It should be noted that step S501 in the foregoing may be omitted. That is, the first network device may configure the configuration parameter sent to the UE without needing to acquire the configuration parameter from the second network device. In addition, the first network device may instruct the second network device to directly send the foregoing configuration parameter to the UE without needing to send the configuration parameter through the first network device. In sum, in this embodiment, a source of the configuration parameter is not limited.

S503. The UE receives the configuration parameter sent by the first network device, and detects, according to the received configuration parameter, whether a failure occurs on a radio link established between the user equipment and the second network device, where the configuration parameter may carry one or more parameters of: the maximum quantity of random access preamble retransmissions, the maximum quantity of RLC uplink data retransmissions, and the duration of the timer, so that the UE may determine, according to any one carried parameter and by using a case, corresponding to the parameter, in the following first, second, and third cases, whether a failure occurs on the radio link established between the UE and the second network device.

Because the second network device may control multiple cells, the UE may establish a radio link to each of the multiple cells controlled by the second network device, that is, the UE may establish multiple radio links to the second network device.

In a first case, when the configuration parameter received by the UE carries the maximum quantity of random access preamble retransmissions, when the UE sends a random access request to the second network device over a radio link established between the UE and a cell controlled by the second network device, if the random access request fails to be sent, the UE resends the random access request to the second network device over the radio link, and counts a first quantity of times, where the first quantity of times is a quantity of times of repeatedly sending the random access request to the second network device by the UE over the radio link. If the first quantity of times is greater than or equal to the maximum quantity of random access preamble retransmissions, the UE determines that a failure occurs on the radio link; otherwise, the UE determines that no failure occurs on the radio link.

In a second case, when the configuration parameter received by the UE carries the duration of a timer, when the UE detects that downlink signal quality of a cell controlled by the second network device is less than or equal to a preset quality threshold, the UE starts the timer. If it is detected that the downlink signal quality of the cell is not greater than the preset quality threshold within the timing duration of the timer, that is, it is detected that the downlink signal quality of the cell keeps less than or equal to the preset quality threshold, it is determined that a failure occurs on a radio link established between the UE and the cell. If it is detected that the downlink signal quality of the cell is greater than the preset quality threshold within the timing duration of the timer, the timer is stopped, and it is determined that no failure occurs on the radio link established between the UE and the cell.

In a third case, when the configuration parameter received by the UE carries the maximum quantity of RLC uplink data retransmissions, when the UE sends RLC uplink data to the second network device over a radio bearer (RB) established between the UE and the second network device, if the RLC uplink data fails to be sent, the UE resends the RLC uplink data to the second network device over the RB, and counts a second quantity of times, where the second quantity of times is a quantity of times of repeatedly sending the RLC uplink data to the second network device by the UE over the RB. If the second quantity of times is greater than or equal to the maximum quantity of RLC uplink data retransmissions, it is determined that a failure occurs on a radio link, bearing the RB, between the UE and the second network device; otherwise, it is determined that no failure occurs on the radio link, bearing the RB, between the UE and the second network device.

If the configuration parameter carries more than one of: the maximum quantity of random access preamble retransmissions, the maximum quantity of RLC uplink data retransmissions and the duration of the timer, it may be determined, according to any one parameter carried in the configuration parameter and by using a case, corresponding to the parameter, in the foregoing first, second, and third cases, whether a failure occurs on the radio link established between the user equipment and the second network device.

A cause of the failure occurring on the radio link established between the UE and the second network device further includes: a random access problem and a reconfiguration failure. The random access problem may include the quantity of random access preamble retransmissions reaching the maximum quantity of random access preamble retransmissions. A case in which a reconfiguration failure occurs may be as follows: When the first network device sends a configuration parameter to the UE, if the UE cannot accept the configuration parameter, the UE determines that the reconfiguration failure occurs, and further determines that a failure occurs on the radio link established between the UE and the second network device.

S504. When the UE detects that a failure occurs on the radio link established between the UE and the second network device, the UE sends a first message to the first network device, where the first message is used for indicating that a failure occurs on the radio link established between the UE and the second network device.

Specifically, if the UE detects that a failure occurs on the radio link established between the UE and the second network device, the UE may send the first message to the first network device over a radio link established between the UE and the first network device. Certainly, the UE may also send the first message to the second network device over a radio link, on which no failure occurs, between the UE and the second network device, and the second network device receives the first message and forwards the first message to the first network device.

S505. The first network device receives the first message, and determines, according to the first message, that a failure occurs on the radio link established between the UE and the second network device.

Content of the first message is the same as that described in Embodiment 1 in the foregoing, for example, the first message may carry a link failure related identifier and/or a link failure cause.

The link failure related identifier may include any one or more of the following identifiers: a cell identifier of a cell corresponding to the radio link on which the failure occurs, an identifier of an SCG (secondary cell group) where a cell corresponding to the radio link on which the failure occurs belongs, an identifier of a TAG (timing advance group) where a cell corresponding to the radio link on which the failure occurs belongs, and an identifier of a bearer corresponding to the radio link on which the failure occurs.

In the embodiment, the identifier of the bearer corresponding to the radio link on which the failure occurs is an identifier of an RB corresponding to the radio link on which the failure occurs, and the identifier of the RB corresponding to the radio link on which the failure occurs is an identifier of an RB served by an SCG where a cell corresponding to the radio link on which the failure occurs belongs.

The link failure cause may be any one of the following causes: a random access problem, a quantity of random access preamble retransmissions reaching or exceeding a maximum quantity of random access preamble retransmissions, a quantity of RLC uplink data retransmissions reaching or exceeding a maximum quantity of RLC uplink data retransmissions, expiration of a timer, and a reconfiguration failure.

Further, when receiving the link failure cause, the first network device may take a corresponding measure according to the link failure cause to avoid that a failure occurs again on the radio link due to the link failure cause. For example, if the link failure cause is the quantity of RLC uplink data retransmissions reaching the maximum quantity of RLC uplink data retransmissions, and a cause that the quantity of RLC uplink data retransmissions reaches the maximum quantity of RLC uplink data retransmissions is that the second quantity of retransmissions is set improperly, the first network device may adjust the maximum quantity of RLC uplink data retransmissions, so as to avoid that a failure occurs again on the radio link established between the UE and the second network device because the maximum quantity of RLC uplink data retransmissions is set improperly.

For example, when the link failure cause is the random access problem, that is, the quantity of random access preamble retransmissions reaching the maximum quantity of random access preamble retransmissions, if a cause that the quantity of random access preamble retransmissions reaches the maximum quantity of random access preamble retransmissions is that the maximum quantity of random access preamble retransmissions is set improperly, the first network device may adjust the maximum quantity of random access preamble retransmissions, so as to avoid that a failure occurs again on the radio link established between the UE and the second network device because the maximum quantity of random access preamble retransmissions is set improperly. If the quantity of random access preamble retransmissions reaches the maximum quantity of random access preamble retransmissions because of a relatively long distance between the UE and the second network device, the first network device may further assist an operator in deploying a new second network device near the UE, so as to shorten the distance between the UE and the second network device, thereby avoiding that a failure occurs again on the radio link established between the UE and the second network device because of the relatively long distance between the UE and the second network device.

For example, when the link failure cause is the expiration of the timer, if the timer expires because the duration of the timer is set improperly, the first network device may adjust the duration of the timer, so as to avoid that a failure occurs again on the radio link established between the UE and the second network device because the duration of the timer is set improperly. If the timer expires because downlink transmit power of the second network device is relatively low, the first network device may assist an operator in increasing the downlink transmit power of the second network device, thereby avoiding that a failure occurs again on the radio link established between the UE and the second network device because the downlink transmit power of the second network device is relatively low.

S506. The first network device sends a second message to the UE according to the first message, where the second message is used for instructing the UE to release a cell, an SCG, a TAG or a bearer.

Specifically, this step may be implemented through steps (1) to (3) as follows, which include the following.

(1). If the first message does not carry the link failure related identifier, the first network device determines the identifier of the SCG where the cell corresponding to the radio link on which the failure occurs belongs, an identifier of a cell included in the SCG, an identifier of a primary cell included in the SCG, or an identifier of a bearer served by the SCG as a first release identifier.

Specifically, if the first message does not carry the link failure related identifier, the first network device determines that a failure occurs on all radio links established between the UE and the second network device, and the first network device acquires the identifier of the SCG where the cell corresponding to the radio link on which the failure occurs belongs, the identifier of the cell included in the SCG, the identifier of the primary cell included in the SCG, or the identifier of the bearer served by the SCG, and determines the identifier of the SCG where the cell corresponding to the radio link on which the failure occurs belongs, the identifier of the cell included in the SCG, the identifier of the primary cell included in the SCG, or the identifier of the bearer served by the SCG as the first release identifier.

The identifier of the bearer served by the SCG may be an identifier of an RB, or may be an identifier of an E-RAB. Preferably, the identifier of the bearer served by the SCG may be an identifier of an RB.

A specific operation of acquiring the identifier of the cell included in the SCG may be as follows: The first network device acquires an identifier of a corresponding cell from a stored correspondence between an identifier of an SCG and an identifier of a cell according to the identifier of the SCG where the cell corresponding to the radio link on which the failure occurs belongs, and determines the acquired identifier of the cell as the identifier of the cell included in the SCG.

Each SCG includes one primary cell, and each SCG may include no secondary cell or include one or more secondary cells. When a failure occurs on a radio link established between the UE and a primary cell included in the SCG, the UE cannot perform data communication with the second network device over a radio link established between the UE and a secondary cell included in the SCG either.

Each SCG may serve one or more RBs, and one RB may be served by both an MCG and one or more SCGs, or may be served by only one SCG.

(2). If the first message carries the link failure related identifier, the first network device determines a first release identifier according to the link failure related identifier.

A specific operation of determining the first release identifier by the first network device according to the link failure related identifier may be as follows: If the link failure related identifier is the identifier of the cell corresponding to the radio link on which the failure occurs, determine the identifier of the cell as the first release identifier; if the link failure related identifier is the identifier of the SCG where the cell corresponding to the radio link on which the failure occurs belongs, determine the identifier of the SCG, an identifier of a cell included in the SCG, an identifier of a primary cell included in the SCG, or an identifier of a bearer served by the SCG as the first release identifier; if the link failure related identifier is the identifier of the TAG where the cell corresponding to the radio link on which the failure occurs belongs, determine the identifier of the TAG or an identifier of a cell included in the TAG as the first release identifier; or if the link failure related identifier is the identifier of the bearer corresponding to the radio link on which the failure occurs, determine an identifier of an SCG serving the bearer, an identifier of a cell included in the SCG, an identifier of a primary cell included in the SCG, or an identifier of a bearer served by the SCG as the first release identifier.

(3). The first network device sends the second message to the UE, where the second message carries the first release identifier.

Optionally, if the first message does not carry the link failure related identifier, the first network device may directly send the second message to the UE, where the second message does not carry the first release identifier either.

S507. The first network device sends a third message to the second network device according to the first message, where the third message is used for instructing the second network device to release a resource used for serving the UE.

Specifically, if the first message does not carry the link failure related identifier, an identifier of the UE is determined as a second release identifier; or if the first message carries the link failure related identifier, a second release identifier is determined according to the link failure related identifier, and the third message is sent to the second network device, where the third message carries the second release identifier.

A specific operation of determining the second release identifier according to the link failure related identifier may be as follows: If the link failure related identifier is the identifier of the cell corresponding to the radio link on which the failure occurs, determine the identifier of the UE and the identifier of the cell as the second release identifier; if the link failure related identifier is the identifier of the SCG where the cell corresponding to the link on which the failure occurs belongs, determine the identifier of the UE as the second release identifier; if the link failure related identifier is the identifier of the TAG where the cell corresponding to the radio link on which the failure occurs belongs, determine the identifier of the UE and the identifier of the TAG as the second release identifier, or determine the identifier of the UE and an identifier of a cell included in the TAG as the second release identifier; or if the link failure related identifier is the identifier of the bearer corresponding to the radio link on which the failure occurs, determine the identifier of the UE as the second release identifier, or determine the identifier of the UE and an identifier of a bearer served by an SCG serving the bearer as the second release identifier.

Because the identifier of the bearer corresponding to the radio link on which the failure occurs is an identifier of an RB, the identifier of the bearer served by the SCG serving the RB may be the identifier of the RB, or may be an identifier of an E-RAB (E-UTRAN radio access bearer) corresponding to the RB. The identifier of the E-RAB is an identifier of an E-RAB corresponding to the RB; the first network device may acquire an identifier of a corresponding E-RAB from a stored correspondence between an identifier of an RB and an identifier of an E-RAB according to the identifier of the RB, and determine the acquired identifier of the E-RAB as the identifier of the E-RAB corresponding to the RB.

S508. The UE receives the second message sent by the first network device, where the second message is used for instructing the UE to release a cell, a secondary cell group (SCG), a timing advance group (TAG) or a bearer; and releases a cell, an SCG, a TAG or a bearer according to the second message.

Specifically, if the second message does not carry the first release identifier, the UE releases an SCG corresponding to the second network device.

If the second message does not carry the first release identifier, it is determined that none of radio links established between the UE and the second network device can be normally used, and the UE releases the SCG corresponding to the second network device.

A specific operation of releasing the SCG corresponding to the second network device by the UE is the same as that described in Embodiment 1 in the foregoing, and is no longer elaborated herein. If the second message carries the first release identifier, the UE releases a cell, an SCG, a TAG or a bearer according to the first release identifier.

A specific operation of releasing a cell, an SCG, a TAG or a bearer according to the first release identifier may be as follows: If the first release identifier is an identifier of a cell and the cell is a secondary cell included in an SCG, release the cell; if the first release identifier is an identifier of a cell and the cell is a primary cell included in an SCG, the first release identifier is an identifier of an SCG, or the first release identifier is identifiers of all cells included in an SCG, release the SCG; if the first release identifier is an identifier of a TAG, release the TAG; if the first release identifier is an identifier of a cell included in a TAG, release a cell included in the TAG; or if the first release identifier is an identifier of a bearer served by an SCG, release the bearer served by the SCG.

Cells included in one TAG may be cells controlled by one network device, or may be cells controlled by multiple network devices. Correspondingly, a specific operation of releasing the cell included in the TAG may be as follows: When cells included in the TAG are cells controlled by one network device, directly release all cells included in the TAG. When cells included in the TAG are cells controlled by multiple network devices, select a cell controlled by the second network device from the cells included in the TAG, and release the selected cell.

A specific operation of releasing the bearer served by the SCG may be as follows.

If the identifier of the bearer served by the SCG is an identifier of an RB, when the RB is served by only the SCG, release the RB, that is, release a PDCP entity, an RLC entity, and a logic channel that are related to the RB; when the RB is served by both an MCG and the SCG, release a part, which is served by the SCG, of the bearer, that is, release an RLC entity and a logic channel, which correspond to the SCG, in RLC entities and logic channels that are related to the bearer.

If the identifier of the bearer served by the SCG is an identifier of an E-RAB, the user equipment acquires an identifier of a corresponding RB from a stored correspondence between an identifier of an RB and an identifier of an E-RAB according to the identifier of the E-RAB. When the RB is served by only the SCG, release the RB, that is, release a PDCP entity, an RLC entity, and a logic channel that are related to the RB. When the RB is served by both an MCG and the SCG, release a part, which is served by the SCG, of the bearer, that is, release an RLC entity and a logic channel, which correspond to the SCG, in RLC entities and logic channels that are related to the bearer.

S509. The second network device receives the third message sent by the first network device, where the third message is used for instructing the second network device to release a resource used for serving the UE; and releases, according to the instruction message, a resource used for serving the UE.

The third message may carry the second release identifier, and a resource used for serving the UE is released according to the second release identifier.

Specifically, the second network device receives the third message. If the second release identifier is the identifier of the UE, a resource used for serving the UE is released; if the second release identifier is the identifier of the UE and an identifier of a cell, a resource, of the cell, used for serving the UE is released; if the second release identifier is the identifier of the UE and an identifier of a TAG, a resource, of the TAG, used for serving the UE is released; if the second release identifier is the identifier of the UE and an identifier of a cell included in a TAG, a resource, of a cell included in the TAG, used for serving the UE is released; or if the second release identifier is the identifier of the UE and an identifier of a bearer served by an SCG serving the bearer, a resource used for serving the bearer of the UE is released.

Cells included in one TAG may be cells controlled by one network device, or may be cells controlled by multiple network devices. Correspondingly, a specific operation of releasing a resource of a cell included in the TAG may be as follows: When cells included in the TAG are cells controlled by one network device, directly release resources of all cells included in the TAG. When cells included in the TAG are cells controlled by multiple network devices, select a cell controlled by the second network device from the cells included in the TAG, and release a resource of the selected cell.

A specific operation of releasing a resource used for serving the bearer of the UE may be as follows: If the identifier of the bearer served by the SCG serving the bearer is an identifier of an RB, acquire an identifier of a corresponding E-RAB from a stored correspondence between an identifier of an RB and an identifier of an E-RAB according to the identifier of the RB, and release a resource used for serving the E-RAB of the UE. If the identifier of the bearer served by the SCG serving the bearer is an identifier of an E-RAB, directly release a resource used for serving the E-RAB of the UE.

In this embodiment, the first network device may instruct only the UE or the second network device to release a resource, or may instruct both the UE and the second network device to release a resource. That is, the first network device may send only the second message or the third message, or may synchronously (or asynchronously) send the second message and the third message, so as to instruct the UE and/or the second network device to release a related resource and configuration, which is not limited in this embodiment.

In this embodiment, when user equipment detects that a radio link failure occurs between the user equipment and a secondary base station, the user equipment reports a message to a master base station, so as to notify the master base station that a radio link failure occurs between the UE and the secondary base station, so that the master base station learns that the radio link failure occurs between the UE and the secondary base station, and therefore unnecessary operations such as reestablishment of an SRB and reactivation of security may be no longer performed. In addition, the master base station may also perform further processing on the radio link failure, for example, release a resource related to the secondary base station and/or the UE, so that the secondary base station reallocates a resource to the UE as soon as possible, thereby effectively shortening a time of user data interruption caused by the radio link failure and improving user experience for a user.

### Embodiment 3

In this embodiment, when a secondary base station detects that a radio link failure occurs between the secondary base station and UE, the secondary base station reports a message to a master base station, so as to notify the master base station that a radio link failure occurs between the UE and the secondary base station. Referring to FIG. 6, FIG. 6 is a flowchart of a method for processing a radio link failure according to this embodiment. As shown in FIG. 6, the method includes the following.

S601. A second network device detects whether a radio link failure occurs between UE and the second network device, that is, the second network device detects whether a failure occurs on a radio link established between the UE and the second network device. When radio links are established between the UE and multiple cells of the second network device, it may be set that a radio link failure occurs between the UE and the second network device (that is, a failure occurs on a radio link established between the UE and the second network device) when a failure occurs on any radio link; or it may be set that a radio link failure occurs between the UE and the second network device (that is, a failure occurs on a radio link established between the UE and the second network device) when a failure occurs on a radio link or some radio links.

S602. Transfer a first message to a first network device when it is detected that a radio link failure occurs between the UE and the second network device, where the first message is used for indicating that a radio link failure occurs between the user equipment and the second network device. That is, a first message is transferred to a first network device when it is detected that a failure occurs on the radio link established between the UE and the second network device, where the first message is used for indicating that a failure occurs on the radio link established between the UE and the second network device; in other words, the first message is used for indicating that a radio link failure occurs between the user equipment and the second network device.

The first network device in the foregoing refers to a master base station, and the second network device refers to a secondary base station. When the secondary base station detects that a radio link failure occurs between the secondary base station and the UE, the secondary base station may report the radio link failure to the master base station, so that the master base station learns that the radio link failure occurs between the UE and the secondary base station, and therefore unnecessary operations such as reestablishment of an SRB and reactivation of security may be no longer performed. In addition, the master base station may also perform further processing on the radio link failure, for example, release a resource related to the secondary base station and/or the UE, so that the secondary base station reallocates a resource to the UE as soon as possible, thereby effectively shortening a time of user data interruption caused by the radio link failure and improving user experience for a user.

Step S601 in the foregoing, that is, the step in which the second network device detects whether a failure occurs on the radio link established between the UE and the second network device may be implemented in the following manners.

In a first manner, when it is detected that a quantity of times of attempting to receive, by the second network device over a first radio link, a random access request sent by the user equipment reaches or exceeds a maximum quantity of times of attempting to receive a random access request, it is determined that a failure occurs on the radio link established between the user equipment and the second network device, where the first radio link is any radio link established between the user equipment and the second network device.

When the second network device attempts to receive, within a current period, a random access request that is sent to the second network device by the UE over a radio link established between the UE and a cell controlled by the second network device, if the second network device does not receive the random access request, the second network device attempts to receive again, within a next period, the random access request that is sent to the second network device by the UE over the radio link, and counts a third quantity of times, where the third quantity of times is the quantity of times of attempting to receive, by the second network device, the random access request that is sent to the second network device by the UE over the radio link. If the third quantity of times is greater than or equal to the maximum quantity of times of attempting to receive a random access request, the second network device determines that a failure occurs on the radio link; otherwise, the second network device determines that no failure occurs on the radio link.

In a second manner, when it is detected that sending physical downlink control channel (PDCCH) information by the second network device over a first radio link to the user equipment reaches or exceeds a maximum quantity of PDCCH retransmissions, it is determined that a failure occurs on the radio link established between the user equipment and the second network device, where the first radio link is any radio link established between the user equipment and the second network device.

When the second network device sends PDCCH information to the UE over a radio link established between the second network device and the UE, if the PDCCH information fails to be sent, the second network device resends the PDCCH information to the UE over the radio link, and counts a fourth quantity of times, where the fourth quantity of times is a quantity of times of repeatedly sending the PDCCH information to the UE by the second network device over the radio link. If the fourth quantity of times is greater than or equal to the maximum quantity of PDCCH retransmissions, it is determined that a failure occurs on the radio link between the UE and the second network device; otherwise, it is determined that no failure occurs on the radio link between the UE and the second network device.

In a third manner, when it is detected that a quantity of radio link control (RLC) downlink data retransmissions by the second network device over a first radio bearer reaches or exceeds a maximum quantity of RLC downlink data retransmissions, it is determined that a failure occurs on the radio link established between the user equipment and the second network device, where the first radio bearer is any radio bearer over which the second network device serves the user equipment, and is borne on one or more radio links established between the user equipment and the second network device.

When the second network device sends RLC downlink data to the UE over an RB borne by the radio link established between the second network device and the UE, if the RLC downlink data fails to be sent, the second network device resends the RLC downlink data to the UE over the RB, and counts a fifth quantity of times, where the fifth quantity of times is a quantity of times of repeatedly sending the RLC downlink data to the UE by the second network device over the RB. If the fifth quantity of times is greater than or equal to the maximum quantity of RLC downlink data retransmissions, it is determined that a failure occurs on the radio link, bearing the RB, between the UE and the second network device; otherwise, it is determined that no failure occurs on the radio link, bearing the RB, between the UE and the second network device.

In a fourth manner, when it is detected that a block error rate of uplink data that is sent by the user equipment and received over a first radio link by the second network device is greater than or equal to a preset block error rate, it is determined that a failure occurs on the radio link established between the user equipment and the second network device, where the first radio link is any radio link established between the user equipment and the second network device.

If the second network device receives, over a radio link established between a cell controlled by the second network device and the UE, uplink data sent to the second network device by the UE, the second network device calculates a block error rate of the received uplink data, and compares the calculated block error rate and the preset block error rate. If the calculated block error rate is greater than or equal to the preset block error rate, it is determined that a failure occurs on the radio link established between the UE and the cell; otherwise, it is determined that no failure occurs on the radio link established between the UE and the cell. Alternatively, if the second network device receives, over an RB borne by a radio link established between a cell controlled by the second network device and the UE, uplink data sent to the second network device by the UE, the second network device calculates a block error rate of the received uplink data, and compares the calculated block error rate and the preset block error rate. If the calculated block error rate is greater than or equal to the preset block error rate, it is determined that a failure occurs on the radio link bearing the RB; otherwise, it is determined that no failure occurs on the radio link bearing the RB.

In a fifth manner, when it is detected that a bit error rate of uplink data that is sent by the user equipment and received over a first radio link by the second network device is greater than or equal to a preset bit error rate, it is determined that a failure occurs on the radio link established between the user equipment and the second network device, where the first radio link is any radio link established between the user equipment and the second network device.

If the second network device receives, over a radio link established between a cell controlled by the second network device and the UE, uplink data sent to the second network device by the UE, the second network device calculates a bit error rate of the received uplink data, and compares the calculated bit error rate and the preset bit error rate. If the calculated bit error rate is greater than or equal to the preset bit error rate, it is determined that a failure occurs on the radio link established between the UE and the cell; otherwise, it is determined that no failure occurs on the radio link established between the UE and the cell. If the second network device receives, over an RB borne by a radio link established between a cell controlled by the second network device and the UE, uplink data sent to the second network device by the UE, the second network device calculates a bit error rate of the received uplink data, and compares the calculated bit error rate and the preset bit error rate. If the calculated bit error rate is greater than or equal to the preset bit error rate, it is determined that a failure occurs on the radio link bearing the RB; otherwise, it is determined that no failure occurs on the radio link bearing the RB.

It should be noted that the maximum quantity of times of attempting to receive a random access request, the maximum quantity of PDCCH retransmissions, the maximum quantity of RLC downlink data retransmissions, the preset block error rate, and the preset bit error rate in the foregoing may be preset in the second network device, or may be configured for the second network device by the first network device, which is described in detail in Embodiment 4 in the following, and is not elaborated herein.

It should be noted that the foregoing first message may be a newly added message, in other words, a dedicatedly set message; when the master base station receives the message, it may be learned, according to the name of the message, that a radio link failure occurs between the UE and the secondary base station. In addition, the first message may also be an information element newly added in an existing message, or, a dedicatedly set information element; when the master base station receives the first message, it may be learned, according to whether the newly added information element is included in the first message, whether a radio link failure occurs between the UE and the secondary base station.

Optionally, the first message may carry an identifier of the UE and a link failure related identifier, and the link failure related identifier may include one or more of the following identifiers: an identifier of a cell corresponding to the radio link on which the failure occurs, an identifier of a secondary cell group (SCG) where a cell corresponding to the radio link on which the failure occurs belongs, an identifier of a timing advance group (TAG) where a cell corresponding to the radio link on which the failure occurs belongs, and an identifier of a bearer corresponding to the radio link on which the failure occurs.

In this way, the master base station may determine, according to the link failure related identifier, to release a resource related to the secondary base station and/or the UE, so that the secondary base station reallocates a resource to the UE as soon as possible, thereby further shortening a time of user data interruption caused by the radio link failure and improving user experience for a user, which is described in detail in Embodiment 4, and is not elaborated herein.

Certainly, the first message may not carry the link failure related identifier. In such a case, when a radio link failure occurs between the secondary base station and the UE, the master base station may avoid unnecessary operations such as reestablishment of an SRB and reactivation of security according to the first message and does not perform further processing. In addition, if only one secondary base station provides a service for the UE, a resource related to the secondary base station and/or the UE may also be released according to the first message.

Optionally, the first message may carry a link failure cause. Certainly, the first message may carry only the link failure related identifier or the link failure cause, or may carry both the link failure related identifier and the link failure cause. When the first message carries the link failure cause, the master base station may locate a failure cause more accurately, and therefore, can recover from a failure at a minimum cost.

The link failure cause in the foregoing may include: a random access problem, a quantity of times of receiving a random access request reaching or exceeding a maximum quantity of times of attempting to receiving a random access request, a quantity of PDCCH retransmissions reaching or exceeding a maximum quantity of PDCCH retransmissions, a quantity of RLC downlink data retransmissions reaching or exceeding a maximum quantity of RLC downlink data retransmissions, a block error rate of uplink data reaching or exceeding a preset block error rate, a bit error rate of uplink data reaching or exceeding a preset bit error rate, an uplink reception problem or a downlink sending problem.

Further, the master base station may instruct the secondary base station and/or the UE to release a related resource after determining, according to the first message, that a failure occurs on the radio link established between the UE and the secondary base station, so that the secondary base station reallocates a resource to the UE as soon as possible, thereby shortening a time of user data interruption caused by the radio link failure and improving user experience for a user.

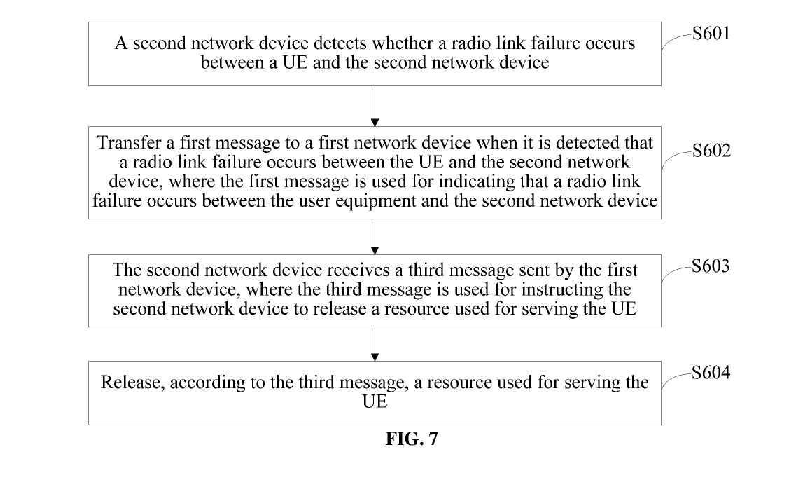

For example, as shown in FIG. 7, after step S602 in the foregoing, the master base station sends a second message to the secondary base station according to the first message, where the second message is used for instructing the secondary base station to release a resource used for serving the UE. In this case, the foregoing method for processing a radio link failure may further include:

S603. The second network device receives a third message sent by the first network device, where the third message is used for instructing the second network device to release a resource used for serving the UE.

S604. Release, according to the third message, a resource used for serving the UE.

Specifically, in step S604 in the foregoing, when the third message includes the identifier of the UE, a resource used for serving the UE is released; or when the third message includes the identifier of the UE and an identifier of a cell, a resource, of the cell, used for serving the UE is released; or when the third message includes the identifier of the UE and an identifier of a TAG, a resource, of the TAG, used for serving the UE is released; or when the third message includes the identifier of the UE and an identifier of a cell in a TAG, a resource, of a cell included in the TAG, used for serving the user equipment is released; or when the third message includes the identifier of the user equipment and an identifier of a bearer, a resource used for serving the bearer of the user equipment is released.

Cells included in one TAG may be cells controlled by one network device, or may be cells controlled by multiple network devices. Correspondingly, a specific operation of releasing a resource of a cell included in the TAG may be as follows: When cells included in the TAG are cells controlled by one network device, directly release resources of all cells included in the TAG. When cells included in the TAG are cells controlled by multiple network devices, select a cell controlled by the second network device from the cells included in the TAG, and release a resource of the selected cell.

A specific operation of releasing a resource used for serving the bearer of the UE may be as follows: If an identifier of a bearer served by an SCG serving the bearer is an identifier of an RB, acquire an identifier of a corresponding E-RAB from a stored correspondence between an identifier of an RB and an identifier of an E-RAB according to the identifier of the RB, and release a resource used for serving the E-RAB of the UE. If an identifier of a bearer served by an SCG serving the bearer is an identifier of an E-RAB, directly release a resource used for serving the E-RAB of the UE.

In this embodiment, when a secondary base station detects that a radio link failure occurs between the secondary base station and UE, the secondary base station reports a message to a master base station, so as to notify the master base station that a radio link failure occurs between the UE and the secondary base station, so that the master base station learns that the radio link failure occurs between the UE and the secondary base station, and therefore unnecessary operations such as reestablishment of an SRB and reactivation of security may be no longer performed. In addition, the master base station may perform further processing on the radio link failure, for example, release a resource related to the secondary base station and/or the UE, so that the secondary base station reallocates a resource to the UE as soon as possible, thereby effectively shortening a time of user data interruption caused by a radio link failure and improving user experience for a user.

With reference to Embodiment 4 in the following, a process in which a master base station performs further processing after learning that a radio link failure occurs between UE and a secondary base station is described.

### Embodiment 4

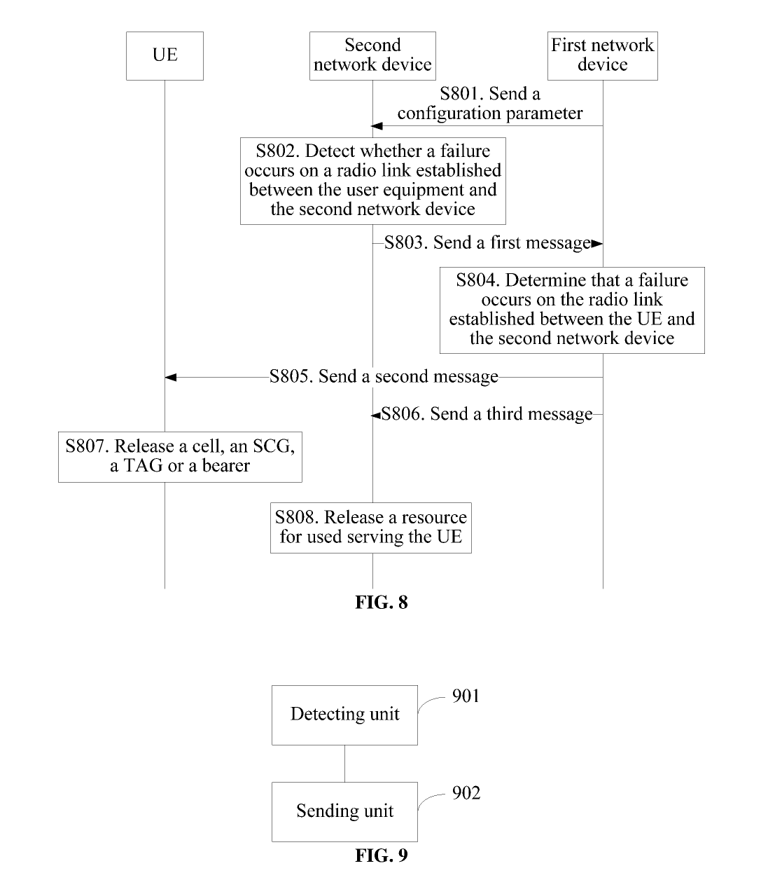

Referring to FIG. 8, FIG. 8 is a signaling flowchart of another method for processing a radio link failure according to an embodiment. As shown in FIG. 8, the method includes the following.

S801. A first network device sends a configuration parameter to a second network device, where the configuration parameter carries one or more of the following parameters: a maximum quantity of times of attempting to receive a random access request, a maximum quantity of PDCCH retransmissions, a maximum quantity of RLC downlink data retransmissions, a block error rate (BLER) threshold of uplink data (or referred to as a preset block error rate), and a bit error rate (BER) threshold of uplink data (or referred to as a preset bit error rate).

S802. The second network device receives the configuration parameter, and detects, according to the received configuration parameter, whether a failure occurs on a radio link established between the second network device and UE.

Because the second network device may control multiple cells, the UE may establish a radio link to each of the multiple cells controlled by the second network device, that is, the UE may establish multiple radio links to the second network device.

In a first case, after the second network device receives the configuration parameter, if the configuration parameter carries the maximum quantity of times of attempting to receive a random access request, when the second network device attempts to receive, within a current period, a random access request that is sent to the second network device by the UE over a radio link established between the UE and a cell controlled by the second network device, if the second network device does not receive the random access request, the second network device attempts to receive again, within a next period, the random access request that is sent to the second network device by the UE over the radio link, and counts a third quantity of times, where the third quantity of times is a quantity of times of attempting to receive, by the second network device, the random access request that is sent to the second network device by the UE over the radio link. If the third quantity of times is greater than or equal to the maximum quantity of times of attempting to receive a random access request, the second network device determines that a failure occurs on the radio link; otherwise, the second network device determines that no failure occurs on the radio link.

In a second case, if the configuration parameter carries the maximum quantity of PDCCH retransmissions, when the second network device sends PDCCH information to the UE over a radio link established between the second network device and the UE, if the PDCCH information fails to be sent, the second network device resends the PDCCH information to the UE over the radio link, and counts a fourth quantity of times, where the fourth quantity of times is a quantity of times of repeatedly sending the PDCCH information to the UE by the second network device over the radio link. If the fourth quantity of times is greater than or equal to the maximum quantity of PDCCH retransmissions, it is determined that a failure occurs on the radio link between the UE and the second network device; otherwise, it is determined that no failure occurs on the radio link between the UE and the second network device.

In a third case, if the configuration parameter carries the maximum quantity of RLC downlink data retransmissions, when the second network device sends RLC downlink data to the UE over an RB borne by the radio link established between the second network device and the UE, if the RLC downlink data fails to be sent, the second network device resends the RLC downlink data to the UE over the RB, and counts a fifth quantity of times, where the fifth quantity of times is a quantity of times of repeatedly sending the RLC downlink data to the UE by the second network device over the RB. If the fifth quantity of times is greater than or equal to the maximum quantity of RLC downlink data retransmissions, it is determined that a failure occurs on the radio link, bearing the RB, between the UE and the second network device; otherwise, it is determined that no failure occurs on the radio link, bearing the RB, between the UE and the second network device.

In a fourth case, if the configuration parameter carries the preset block error rate, and if the second network device receives, over a radio link established between a cell controlled by the second network device and the UE, uplink data sent to the second network device by the UE, the second network device calculates a block error rate of the received uplink data, and compares the calculated block error rate and the preset block error rate. If the calculated block error rate is greater than or equal to the preset block error rate, it is determined that a failure occurs on the radio link established between the UE and the cell; otherwise, it is determined that no failure occurs on the radio link established between the UE and the cell. If the second network device receives, over an RB borne by a radio link established between a cell controlled by the second network device and the UE, uplink data sent to the second network device by the UE, the second network device calculates a block error rate of the received uplink data, and compares the calculated block error rate and the preset block error rate. If the calculated block error rate is greater than or equal to the preset block error rate, it is determined that a failure occurs on the radio link bearing the RB; otherwise, it is determined that no failure occurs on the radio link bearing the RB.

In a fifth case, if the configuration parameter carries the preset bit error rate, and if the second network device receives, over a radio link established between a cell controlled by the second network device and the UE, uplink data sent to the second network device by the UE, the second network device calculates a bit error rate of the received uplink data, and compares the calculated bit error rate and the preset bit error rate. If the calculated bit error rate is greater than or equal to the preset bit error rate, it is determined that a failure occurs on the radio link established between the UE and the cell; otherwise, it is determined that no failure occurs on the radio link established between the UE and the cell. If the second network device receives, over an RB borne by a radio link established between a cell controlled by the second network device and the UE, uplink data sent to the second network device by the UE, the second network device calculates a bit error rate of the received uplink data, and compares the calculated bit error rate and the preset bit error rate. If the calculated bit error rate is greater than or equal to the preset bit error rate, it is determined that a failure occurs on the radio link bearing the RB; otherwise, it is determined that no failure occurs on the radio link bearing the RB.

If the configuration parameter carries more than one of: a maximum quantity of times of attempting to receive a random access request, a maximum quantity of PDCCH retransmissions, a maximum quantity of RLC downlink data retransmissions, a preset block error rate, and a preset bit error rate, it may be determined, according to any one parameter and by using a case, corresponding to the parameter, in the foregoing first to fifth cases, whether a failure occurs on the radio link established between the UE and the second network device.

A cause of the failure occurring on the radio link established between the UE and the second network device further includes: an uplink reception problem and a downlink sending problem. The uplink reception problem includes a quantity of times of receiving a random access request reaching or exceeding the maximum quantity of times of attempting to receive a random access request, the BLER of uplink data reaching or exceeding the preset block error rate and the BER of uplink data reaching or exceeding the preset bit error rate. The downlink sending problem includes the quantity of PDCCH retransmissions reaching or exceeding the maximum quantity of PDCCH retransmissions, and the quantity of RLC downlink data retransmissions reaching or exceeding the maximum quantity of RLC downlink data retransmissions.

Optionally, the first network device may not send the configuration parameter to the second network device, and instead, the second network device configures one or more of: the maximum quantity of times of attempting to receive a random access request, the maximum quantity of PDCCH retransmissions, the maximum quantity of RLC downlink data retransmissions, the preset block error rate, and the preset bit error rate. The second network device detects, according to the foregoing parameter configured by the second network device, the radio link established between the second network device and the UE.

S803. When the second network device detects that a failure occurs on the radio link established between the second network device and the UE, the second network device sends a first message to the first network device, where the first message is used for indicating that a failure occurs on the radio link established between the UE and the second network device.

Specifically, if the second network device detects that a failure occurs on the radio link established between the second network device and the UE, the second network device may send the first message to the first network device over a wired link established between the second network device and the first network device; certainly, the second network device may send the first message to the first network device in a wireless manner, which is not limited in this embodiment.

S804. The first network device receives the first message, and determines, according to the first message, that a failure occurs on the radio link established between the UE and the second network device.

Content of the first message is the same as that described in Embodiment 3 in the foregoing, for example, the first message may carry an identifier of the UE, and a link failure related identifier and/or a link failure cause.

The link failure related identifier may include any one or more of the following identifiers: an identifier of a cell corresponding to the radio link on which the failure occurs, an identifier of an SCG where a cell corresponding to the radio link on which the failure occurs belongs, an identifier of a TAG where a cell corresponding to the radio link on which the failure occurs belongs, and an identifier of a bearer corresponding to the radio link on which the failure occurs.

In this embodiment, the identifier of the bearer corresponding to the radio link on which the failure occurs may be an identifier of an E-RAB corresponding to the radio link on which the failure occurs.

The link failure cause may be any one of the following causes: a random access problem, a quantity of times of receiving a random access request reaching or exceeding a maximum quantity of times of attempting to receive a random access request, a quantity of PDCCH retransmissions reaching or exceeding a maximum quantity of PDCCH retransmissions, a quantity of RLC downlink data retransmissions reaching or exceeding a maximum quantity of RLC downlink data retransmissions, a BLER of the uplink data reaching or exceeding a preset block error rate, a BER of the uplink data reaching or exceeding a preset bit error rate, an uplink reception problem, and a downlink sending problem. Further, when receiving the link failure cause, the first network device may take a corresponding measure according to the link failure cause to avoid that a failure occurs again on the radio link due to the link failure cause. For example, when the link failure cause is the quantity of times of receiving a random access request reaching the maximum quantity of times of attempting to receive a random access request, and a cause that the quantity of times of receiving a random access request reaches the maximum quantity of times of attempting to receive a random access request is that the maximum quantity of times of attempting to receive a random access request is set improperly, the first network device may adjust the maximum quantity of times of attempting to receive a random access request, so as to avoid that a failure occurs again on the radio link established between the UE and the second network device because the maximum quantity of times of attempting to receive a random access request is set improperly. If a cause that the quantity of times of receiving a random access request reaches the maximum quantity of times of attempting to receive a random access request is that a distance between the UE and the second network device is relatively long, the first network device may further assist an operator in deploying a new second network device near the UE, so as to shorten the distance between the UE and the second network device, thereby avoiding that a failure occurs again on the radio link established between the UE and the second network device because of the distance between the UE and the second network device.

For example, when the link failure cause is the quantity of PDCCH retransmissions reaching the maximum quantity of PDCCH retransmissions, and a cause that the quantity of PDCCH retransmissions reaches the maximum quantity of PDCCH retransmissions is that the maximum quantity of PDCCH retransmissions is set improperly, the first network device may adjust the maximum quantity of PDCCH retransmissions, so as to avoid that a failure occurs again on the radio link established between the UE and the second network device because the maximum quantity of PDCCH retransmissions is set improperly.

For example, when the link failure cause is the quantity of RLC downlink data retransmissions reaching the maximum quantity of RLC downlink data retransmissions, and a cause that the quantity of RLC downlink data retransmissions reaches the maximum quantity of RLC downlink data retransmissions is that the maximum quantity of RLC downlink data retransmissions is set improperly, the first network device may adjust the maximum quantity of RLC downlink data retransmissions, so as to avoid that a failure occurs again on the radio link established between the UE and the second network device because the maximum quantity of RLC downlink data retransmissions is set improperly.

For example, when the link failure cause is the BLER of uplink data exceeding the preset block error rate, and a cause that the BLER of uplink data exceeds the preset block error rate is that the preset block error rate is set improperly, the first network device may adjust the preset block error rate, so as to avoid that a failure occurs again on the radio link established between the UE and the second network device because the preset block error rate is set improperly.

For example, when the link failure cause is the BER of uplink data exceeding the preset bit error rate, and a cause that the BER of uplink data exceeds the preset bit error rate is that the preset bit error rate is set improperly, the first network device may adjust the preset bit error rate, so as to avoid that a failure occurs again on the radio link established between the UE and the second network device because the preset bit error rate is set improperly.

S805. The first network device sends a second message to the UE according to the first message, where the second message is used for instructing the UE to release a cell, an SCG, a TAG or a bearer.

Specifically, this step may be implemented through steps (1) to (3) as follows, which include the following.

(1). If the first message does not carry the link failure related identifier, the first network device determines the identifier of the SCG where the cell corresponding to the radio link on which the failure occurs belongs, an identifier of a cell included in the SCG, an identifier of a primary cell included in the SCG, or an identifier of a bearer served by the SCG as a first release identifier.

Specifically, if the first message does not carry the link failure related identifier, the first network device determines that a failure occurs on all radio links established between the UE and the second network device, and the first network device acquires the identifier of the SCG where the cell corresponding to the radio link on which the failure occurs belongs, the identifier of the cell included in the SCG, the identifier of the primary cell included in the SCG, or the identifier of the bearer served by the SCG, and determines the identifier of the SCG where the cell corresponding to the radio link on which the failure occurs belongs, the identifier of the cell included in the SCG, the identifier of the primary cell included in the SCG, or the identifier of the bearer served by the SCG as the first release identifier.

The identifier of the bearer served by the SCG may be an identifier of an RB, or may be an identifier of an E-RAB. Preferably, the identifier of the bearer served by the SCG may be an identifier of an RB.

A specific operation of acquiring the identifier of the cell included in the SCG may be as follows: The first network device acquires an identifier of a corresponding cell from a stored correspondence between an identifier of an SCG and an identifier of a cell according to the identifier of the SCG where the cell corresponding to the radio link on which the failure occurs belongs, and determines the acquired identifier of the cell as the identifier of the cell included in the SCG.

Each SCG includes one primary cell, and each SCG may include no secondary cell or include one or more secondary cells. When a failure occurs on a radio link established between the UE and a primary cell included in the SCG, the UE cannot perform data communication with the second network device over a radio link established between the UE and a secondary cell included in the SCG either.

Each SCG may serve one or more RBs, and one RB may be served by both an MCG and one or more SCGs, or may be served by only one SCG.

(2). If the first message carries the link failure related identifier, the first network device determines a first release identifier according to the link failure related identifier.

A specific operation of determining the first release identifier by the first network device according to the link failure related identifier may be as follows: If the link failure related identifier is the identifier of the cell corresponding to the radio link on which the failure occurs, determine the identifier of the cell as the first release identifier; if the link failure related identifier is the identifier of the SCG where the cell corresponding to the radio link on which the failure occurs belongs, determine the identifier of the SCG, an identifier of a cell included in the SCG, an identifier of a primary cell included in the SCG, or an identifier of a bearer served by the SCG as the first release identifier; if the link failure related identifier is the identifier of the TAG where the cell corresponding to the radio link on which the failure occurs belongs, determine the identifier of the TAG or an identifier of a cell included in the TAG as the first release identifier; or if the link failure related identifier is the identifier of the bearer corresponding to the radio link on which the failure occurs, determine an identifier of an SCG serving the bearer, an identifier of a cell included in the SCG, an identifier of a primary cell included in the SCG, or an identifier of a bearer served by the SCG as the first release identifier.

(3). The first network device sends the second message to the UE, where the second message carries the first release identifier.

Optionally, if the first message does not carry the link failure related identifier, the first network device may directly send the second message to the UE, where the second message does not carry the first release identifier either.

S806. The first network device sends a third message to the second network device according to the first message, where the third message is used for indicating that the second network device needs to release a resource used for serving the UE.

Specifically, if the first message does not carry the link failure related identifier, the identifier of the UE is determined as a second release identifier; or if the first message carries the link failure related identifier, a second release identifier is determined according to the link failure related identifier, and the third message is sent to the second network device, where the third message carries the second release identifier.

A specific operation of determining the second release identifier according to the link failure related identifier may be as follows: If the link failure related identifier is the identifier of the cell corresponding to the radio link on which the failure occurs, determine the identifier of the UE and the identifier of the cell as the second release identifier; if the link failure related identifier is the identifier of the SCG where the cell corresponding to the link on which the failure occurs belongs, determine the identifier of the UE as the second release identifier; if the link failure related identifier is the identifier of the TAG where the cell corresponding to the radio link on which the failure occurs belongs, determine the identifier of the UE and the identifier of the TAG as the second release identifier, or determine the identifier of the UE and an identifier of a cell included in the TAG as the second release identifier; or if the link failure related identifier is the identifier of the bearer corresponding to the radio link on which the failure occurs, determine the identifier of the UE as the second release identifier, or determine the identifier of the UE and an identifier of a bearer served by an SCG serving the bearer as the second release identifier.

Because the identifier of the bearer corresponding to the radio link on which the failure occurs is an identifier of an RB, the identifier of the bearer served by the SCG serving the RB may be the identifier of the RB, or may be an identifier of an E-RAB (E-UTRAN radio access bearer) corresponding to the RB. The identifier of the E-RAB is an identifier of an E-RAB corresponding to the RB; the first network device may acquire an identifier of a corresponding E-RAB from a stored correspondence between an identifier of an RB and an identifier of an E-RAB according to the identifier of the RB, and determine the acquired identifier of the E-RAB as the identifier of the E-RAB corresponding to the RB.

S807. The UE receives the second message sent by the first network device, where the second message is used for instructing the UE to release a cell, a secondary cell group (SCG), a timing advance group (TAG) or a bearer; and releases a cell, an SCG, a TAG or a bearer according to the second message.

Specifically, if the second message does not carry the first release identifier, the UE releases an SCG corresponding to the second network device.

If the second message does not carry the first release identifier, it is determined that none of radio links established between the UE and the second network device can be normally used, and the UE releases the SCG corresponding to the second network device.

A specific operation of releasing the SCG corresponding to the second network device by the UE is the same as that described in Embodiment 1 in the foregoing, and is no longer elaborated herein. If the second message carries the first release identifier, the UE releases a cell, an SCG, a TAG or a bearer according to the first release identifier.

A specific operation of releasing a cell, an SCG, a TAG or a bearer according to the first release identifier may be as follows: If the first release identifier is an identifier of a cell and the cell is a secondary cell included in an SCG, release the cell; if the first release identifier is an identifier of a cell and the cell is a primary cell included in an SCG, the first release identifier is an identifier of an SCG or the first release identifier is identifiers of all cells included in an SCG, release the SCG; if the first release identifier is an identifier of a TAG, release the TAG; if the first release identifier is an identifier of a cell included in a TAG, release a cell included in the TAG; or if the first release identifier is an identifier of a bearer served by an SCG, release the bearer served by the SCG.

Cells included in one TAG may be cells controlled by one network device, or may be cells controlled by multiple network devices. Correspondingly, a specific operation of releasing the cell included in the TAG may be as follows: When cells included in the TAG are cells controlled by one network device, directly release all cells included in the TAG. When cells included in the TAG are cells controlled by multiple network devices, select a cell controlled by the second network device from the cells included in the TAG, and release the selected cell.

A specific operation of releasing the bearer served by the SCG may be as follows.

If the identifier of the bearer served by the SCG is an identifier of an RB, when the RB is served by only the SCG, release the RB, that is, release a PDCP entity, an RLC entity, and a logic channel related to the RB. When the RB is served by both an MCG and the SCG, release a part, which is served by the SCG, of the bearer, that is, release an RLC entity and a logic channel, which correspond to the SCG, in RLC entities and logic channels that are related to the bearer.

If the identifier of the bearer served by the SCG is an identifier of an E-RAB, the UE acquires an identifier of a corresponding RB from a stored correspondence between an identifier of an RB and an identifier of an E-RAB according to the identifier of the E-RAB. When the RB is served by only the SCG, release the RB, that is, release a PDCP entity, an RLC entity, and a logic channel that are related to the RB. When the RB is served by both an MCG and the SCG, release a part, which is served by the SCG, of the bearer, that is, release an RLC entity and a logic channel, which correspond to the SCG, in RLC entities and logic channels that are related to the bearer.

S808. The second network device receives the third message sent by the first network device, where the third message is used for instructing the second network device to release a resource used for serving the UE; and releases, according to the instruction message, a resource used for serving the UE.

The third message may carry the second release identifier, and a resource used for serving the UE is released according to the second release identifier.

Specifically, the second network device receives the third message. If the second release identifier is the identifier of the UE, a resource used for serving the UE is released; if the second release identifier is the identifier of the UE and an identifier of a cell, a resource, of the cell, used for serving the UE is released; if the second release identifier is the identifier of the UE and an identifier of a TAG, a resource, of the TAG, used for serving the UE is released; if the second release identifier is the identifier of the UE and an identifier of a cell included in a TAG, a resource, of a cell included in the TAG, used for serving the UE is released; or if the second release identifier is the identifier of the UE and an identifier of a bearer served by an SCG serving the bearer, a resource used for serving the bearer of the UE is released.

Cells included in one TAG may be cells controlled by one network device, or may be cells controlled by multiple network devices. Correspondingly, a specific operation of releasing a resource of a cell included in the TAG may be as follows: When cells included in the TAG are cells controlled by one network device, directly release resources of all cells included in the TAG. When cells included in the TAG are cells controlled by multiple network devices, select a cell controlled by the second network device from the cells included in the TAG, and release a resource of the selected cell.

A specific operation of releasing a resource used for serving the bearer of the UE may be as follows: If the identifier of the bearer served by the SCG serving the bearer is an identifier of an RB, acquire an identifier of a corresponding E-RAB from a stored correspondence between an identifier of an RB and an identifier of an E-RAB according to the identifier of the RB, and release a resource used for serving the E-RAB of the UE. If the identifier of the bearer served by the SCG serving the bearer is an identifier of an E-RAB, directly release a resource used for serving the E-RAB of the UE.

In this embodiment, the first network device may instruct only the UE or the second network device to release a resource, or may instruct both the UE and the second network device to release a resource. That is, the first network device may send only the second message or the third message, or may synchronously (or asynchronously) send the second message and the third message, so as to instruct the UE and/or the second network device to release a related resource and configuration, which is not limited in this embodiment.

In this embodiment, when a secondary base station detects that a radio link failure occurs between the secondary base station and UE, the secondary base station reports a message to a master base station, so as to notify the master base station that a radio link failure occurs between the UE and the secondary base station, so that the master base station learns that the radio link failure occurs between the UE and the secondary base station, and therefore unnecessary operations such as reestablishment of an SRB and reactivation of security may be no longer performed. In addition, the master base station may also perform further processing on the radio link failure, for example, release a resource related to the secondary base station and/or the UE, so that the secondary base station reallocates a resource to the UE as soon as possible, thereby effectively shortening a time of user data interruption caused by the radio link failure and improving user experience for a user.

### Embodiment 5

This embodiment provides a device for processing a radio link failure, which is located on a user equipment side. Referring to FIG. 9, the device includes a detecting unit 901, configured to detect whether a failure occurs on a radio link established between user equipment and a second network device. The device also includes a sending unit 902, configured to: when the detecting unit 901 detects that a failure occurs on the radio link established between the user equipment and the second network device, send a first message to a first network device, where the first message is used for indicating that a failure occurs on the radio link established between the user equipment and the second network device.

The detecting unit 901 is configured to determine that a failure occurs on the radio link established between the user equipment and the second network device when it is detected that a quantity of random access request retransmissions by the user equipment over a first radio link reaches or exceeds a maximum quantity of random access preamble retransmissions, where the first radio link is any radio link established between the user equipment and the second network device. Or, when it is detected that a timer corresponding to a first cell reaches or exceeds duration of the timer, determine that a failure occurs on the radio link established between the user equipment and the second network device, where the first cell is any cell of the second network device. Or, when it is detected that a quantity of radio link control (RLC) uplink data retransmissions by the user equipment over a first radio bearer reaches or exceeds a maximum quantity of RLC uplink data retransmissions, determine that a failure occurs on the radio link established between the user equipment and the second network device, where the first radio bearer is any radio bearer over which the second network device serves the user equipment, and is borne on one or more radio links established between the user equipment and the second network device.

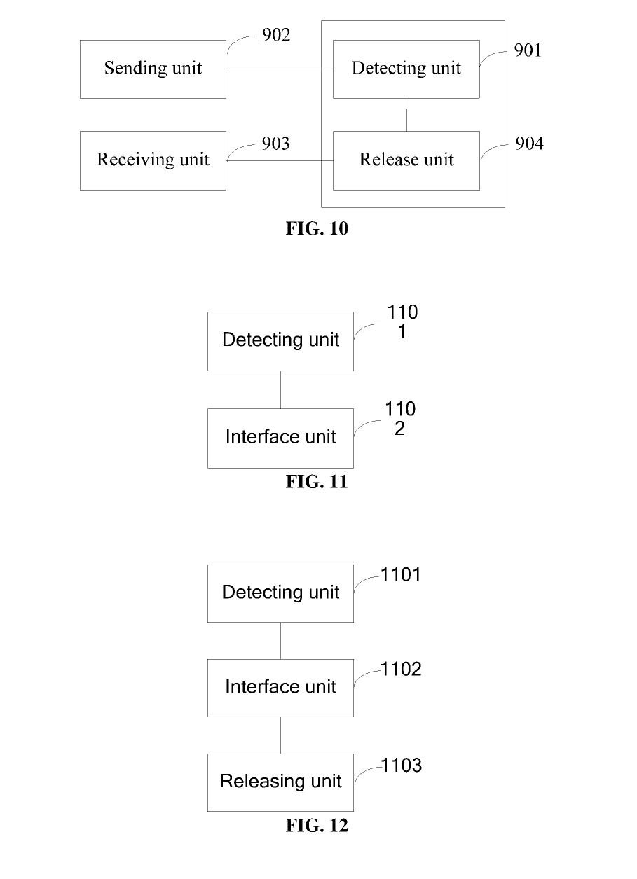

Preferably, referring to FIG. 10, the device for processing a radio link failure further includes a receiving unit 903, configured to receive a configuration parameter. The configuration parameter includes one or more of the following parameters: the maximum quantity of random access preamble retransmissions, duration of a timer, and the maximum quantity of RLC uplink data retransmissions, where the configuration parameter is acquired by the first network device from the second network device and sent to the user equipment, or the configuration parameter is sent by the second network device to the user equipment.

Further, the first message carries a link failure related identifier, and the link failure related identifier includes one or more of the following identifiers: an identifier of a cell corresponding to the radio link on which the failure occurs, an identifier of a secondary cell group (SCG) where a cell corresponding to the radio link on which the failure occurs belongs, an identifier of a timing advance group (TAG) where a cell corresponding to the radio link on which the failure occurs belongs, and an identifier of a bearer corresponding to the radio link on which the failure occurs.

Preferably, the first message carries a link failure cause.

Further, the link failure cause includes: a random access problem, a quantity of random access preamble retransmissions reaching or exceeding a maximum quantity of random access preamble retransmissions, a quantity of RLC uplink data retransmissions reaching or exceeding a maximum quantity of RLC uplink data retransmissions, expiration of a timer, or a reconfiguration failure.

The receiving unit 903 is further configured to receive an instruction message sent by the first network device, where the instruction message is used for instructing the user equipment to release a cell, a secondary cell group (SCG), a timing advance group (TAG) or a bearer; and the device further includes a releasing unit 904, configured to release a cell, an SCG, a TAG or a bearer according to the instruction message.

Further, the releasing unit 904 is configured to release an SCG corresponding to the second network device when the instruction message does not carry a release identifier. Or, when the instruction message carries a release identifier, release a cell, an SCG, a TAG or a bearer according to the release identifier.

When the instruction message carries the release identifier, the releasing unit 904 is configured to release the cell when the release identifier is an identifier of a cell and the cell is a secondary cell in an SCG. Or, when the release identifier is an identifier of a cell and the cell is a primary cell in an SCG, or when the release identifier is an identifier of an SCG, or when the release identifier is identifiers of all cells included in an SCG, release the SCG. Or, when the release identifier is an identifier of a TAG, release the TAG. Or, when the release identifier is an identifier of a cell in a TAG, release a cell that is in the TAG and is controlled by the second network device. Or, when the release identifier is an identifier of a bearer served by an SCG, release the bearer served by the SCG.

It should be noted that the receiving unit in this embodiment may be a receiver of the UE, and the sending unit may be a transmitter of the UE. In addition, the receiving unit and the sending unit may also be integrated to form a transceiver of the UE. The detecting unit may be a separately disposed processor, or may be integrated in a processor of the UE for implementation, or may be stored in a memory of the UE in the form of program code, and a processor of the UE invokes and executes the function of the foregoing detecting unit. The implementation of the releasing unit is the same as that of the detecting unit, and the releasing unit may be integrated with the detecting unit or may be implemented separately. The processor herein may be one central processing unit (CPU), or an application specific integrated circuit (ASIC), or one or more integrated circuits configured to implement this embodiment.

In this embodiment, when user equipment detects that a radio link failure occurs between the user equipment and a secondary base station, the user equipment reports a message to a master base station, so as to notify the master base station that a radio link failure occurs between the UE and the secondary base station, so that the master base station learns that the radio link failure occurs between the UE and the secondary base station, and therefore unnecessary operations such as reestablishment of an SRB and reactivation of security may be no longer performed. In addition, the master base station may also perform further processing on the radio link failure, for example, release a resource related to the secondary base station and/or the UE, so that the secondary base station reallocates a resource to the UE as soon as possible, thereby effectively shortening a time of user data interruption caused by the radio link failure and improving user experience for a user.

### Embodiment 6

This embodiment provides a device for detecting a radio link failure, which is located on a second network device side. Referring to FIG. 11, the device includes a detecting unit 1101, configured to detect whether a failure occurs on a radio link established between user equipment and a second network device. The device also includes an interface unit 1102, configured to: transfer a first message to a first network device when the detecting unit 1101 detects that a failure occurs on the radio link established between the user equipment and the second network device, where the first message is used for indicating that a failure occurs on the radio link established between the user equipment and the second network device.

The detecting unit 1101 is configured to determine that a failure occurs on the radio link established between the user equipment and the second network device when it is detected that a quantity of times of attempting to receive, by the second network device over a first radio link, a random access request sent by the user equipment reaches or exceeds a maximum quantity of times of attempting to receive a random access request, where the first radio link is any radio link established between the user equipment and the second network device. Or, when it is detected that sending physical downlink control channel (PDCCH) information by the second network device to the user equipment over a first radio link reaches or exceeds a maximum quantity of PDCCH retransmissions, determine that a failure occurs on the radio link established between the user equipment and the second network device, where the first radio link is any radio link established between the user equipment and the second network device. Or, when it is detected that a quantity of radio link control (RLC) downlink data retransmissions by the second network device over a first radio bearer reaches or exceeds a maximum quantity of RLC downlink data retransmissions, determine that a failure occurs on the radio link established between the user equipment and the second network device, where the first radio bearer is any radio bearer over which the second network device serves the user equipment, and is borne on one or more radio links established between the user equipment and the second network device. Or, when it is detected that a block error rate of uplink data that is sent by the user equipment and received over a first radio link by the second network device is greater than or equal to a preset block error rate, determine that a failure occurs on the radio link established between the user equipment and the second network device, where the first radio link is any radio link established between the user equipment and the second network device. Or, when it is detected that a bit error rate of uplink data that is sent by the user equipment and received over a first radio link by the second network device is greater than or equal to a preset bit error rate, determine that a failure occurs on the radio link established between the user equipment and the second network device, where the first radio link is any radio link established between the user equipment and the second network device.

Further, the interface unit 1102 is further configured to receive a configuration parameter sent by the first network device, where the configuration parameter includes one or more of the following parameters: a maximum quantity of times of attempting to receive a random access request, a maximum quantity of PDCCH retransmissions, a maximum quantity of RLC downlink data retransmissions, a preset block error rate, and a preset bit error rate.

Preferably, the first message carries an identifier of the user equipment and a link failure related identifier, and the link failure related identifier includes one or more of the following identifiers: an identifier of a cell corresponding to the radio link on which the failure occurs, an identifier of a secondary cell group (SCG) where a cell corresponding to the radio link on which the failure occurs belongs, an identifier of a timing advance group (TAG) where a cell corresponding to the radio link on which the failure occurs belongs, and an identifier of a bearer corresponding to the radio link on which the failure occurs.

Further, the first message carries a link failure cause.

The link failure cause includes: a quantity of times of receiving a random access request reaching or exceeding a maximum quantity of times of attempting to receive a random access request, a quantity of PDCCH retransmissions reaching or exceeding a maximum quantity of PDCCH retransmissions, a quantity of RLC downlink data retransmissions reaching or exceeding a maximum quantity of RLC downlink data retransmissions, a block error rate of uplink data reaching or exceeding the preset block error rate, a bit error rate of uplink data reaching or exceeding the preset bit error rate, an uplink reception problem or a downlink sending problem.

Further, the interface unit 1102 is further configured to receive an instruction message sent by the first network device, where the instruction message is used for instructing the second network device to release a resource used for serving the user equipment; and as shown in FIG. 12, the device further includes a releasing unit 1103, configured to release, according to the instruction message, a resource used for serving the user equipment.

Further, the releasing unit 1103 is configured to release a resource used for serving the user equipment when the instruction message includes the identifier of the user equipment. Or, when the instruction message includes the identifier of the user equipment and an identifier of a cell, release a resource, of the cell, used for serving the user equipment. Or, when the instruction message includes the identifier of the user equipment and an identifier of a TAG, release a resource, of the TAG, used for serving the user equipment. Or, when the instruction message includes the identifier of the user equipment and an identifier of a cell included in a TAG, release a resource, of a cell included in the TAG and controlled by the second network device, used for serving the UE. Or, when the instruction message includes the identifier of the user equipment and an identifier of a bearer, release a resource used for serving the bearer of the user equipment.

It should be noted that the interface unit in this embodiment may be an interface circuit through which the second network device communicates with the first network device. The detecting unit may be a separately disposed processor, or may be integrated in a processor of the second network device for implementation, or may be stored in a memory of the second network device in the form of program code, and a processor of the second network device invokes and executes the function of the foregoing detecting unit. The implementation of the releasing unit is the same as that of the detecting unit, and the releasing unit may be integrated with the detecting unit or may be implemented separately. The processor herein may be a central processing unit (CPU), an application specific integrated circuit (ASIC), or one or more integrated circuits configured to implement this embodiment.

In this embodiment, when a secondary base station detects that a radio link failure occurs between the secondary base station and UE, the secondary base station reports a message to a master base station, so as to notify the master base station that a radio link failure occurs between the UE and the secondary base station, so that the master base station learns that the radio link failure occurs between the UE and the secondary base station, and therefore unnecessary operations such as reestablishment of an SRB and reactivation of security may be no longer performed. In addition, the master base station may also perform further processing on the radio link failure, for example, release a resource related to the secondary base station and/or the UE, so that the secondary base station reallocates a resource to the UE as soon as possible, thereby effectively shortening a time of user data interruption caused by the radio link failure and improving user experience for a user.

### Embodiment 7

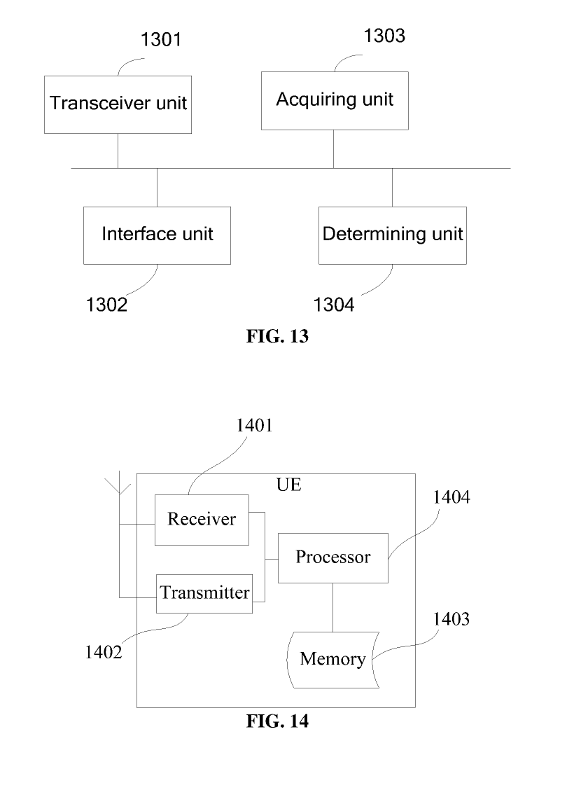

This embodiment provides a device for detecting a radio link failure, which is located on a first network device side. Referring to FIG. 13, the device includes a transceiver unit 1301, configured to communicate with user equipment; an interface unit 1302, configured to communicate with a second network device; an acquiring unit 1303, configured to acquire a first message from the user equipment or the second network device through the transceiver unit 1301 or the interface unit 1302, where the first message is reported to a first network device by the user equipment or the second network device when a failure occurs on a radio link established between the user equipment and the second network device; and a determining unit 1304, configured to determine, according to the first message, that a failure occurs on the radio link established between the user equipment and the second network device.

The first message carries a link failure related identifier, and the link failure related identifier includes one or more of the following identifiers: an identifier of a cell corresponding to the radio link on which the failure occurs, an identifier of a secondary cell group (SCG) where a cell corresponding to the radio link on which the failure occurs belongs, an identifier of a timing advance group (TAG) where a cell corresponding to the radio link on which the failure occurs belongs, and an identifier of a bearer corresponding to the radio link on which the failure occurs.

Further, the first message further carries an identifier of the user equipment.

Preferably, the first message carries a link failure cause.

The link failure cause includes: a random access problem, a quantity of random access preamble retransmissions reaching or exceeding a maximum quantity of random access preamble retransmissions, a quantity of RLC uplink data retransmissions reaching or exceeding a maximum quantity of RLC uplink data retransmissions, expiration of a timer, a reconfiguration failure, a quantity of times of receiving a random access request reaching or exceeding a maximum quantity of times of attempting to receive a random access request, a quantity of PDCCH retransmissions reaching or exceeding a maximum quantity of PDCCH retransmissions, a quantity of RLC downlink data retransmissions reaching or exceeding a maximum quantity of RLC downlink data retransmissions, a block error rate of uplink data reaching or exceeding a preset block error rate, a bit error rate of uplink data reaching or exceeding a preset bit error rate, an uplink reception problem or a downlink sending problem.

Further, after the determining unit 1304 determines that a failure occurs on the radio link established between the user equipment and the second network device, the determining unit 1304 is further configured to trigger the transceiver unit 1301 to send a second message to the user equipment, where the second message is used for instructing the user equipment to release a cell, a secondary cell group (SCG), a timing advance group (TAG) or a bearer; and/or trigger the interface unit 1302 to send a third message to the second network device, where the third message is used for instructing the second network device to release a resource used for serving the user equipment.

Further, the determining unit 1304 is further configured to trigger the transceiver unit 1301 to send, to the user equipment, the second message carrying a first release identifier. When the first message does not carry the link failure related identifier, the first release identifier includes the identifier of the SCG where the cell corresponding to the radio link on which the failure occurs belongs, an identifier of a cell included in the SCG, an identifier of a primary cell included in the SCG, or an identifier of a bearer served by the SCG. Or, when the first message carries the link failure related identifier, the first release identifier is determined according to the link failure related identifier.

When the first message carries the link failure related identifier the first release identifier includes the identifier of the cell when the link failure related identifier includes the identifier of the cell corresponding to the radio link on which the failure occurs. Or, when the link failure related identifier includes the identifier of the SCG where the cell corresponding to the radio link on which the failure occurs belongs, the first release identifier includes the identifier of the SCG, an identifier of a cell included in the SCG, an identifier of a primary cell included in the SCG, or an identifier of a bearer served by the SCG. Or, when the link failure related identifier includes the identifier of the TAG where the cell corresponding to the radio link on which the failure occurs belongs, the first release identifier includes the identifier of the TAG or an identifier of a cell included in the TAG. Or, when the link failure related identifier includes the identifier of the bearer corresponding to the radio link on which the failure occurs, the first release identifier includes an identifier of an SCG serving the bearer, an identifier of a cell included in the SCG, an identifier of a primary cell included in the SCG, or an identifier of a bearer served by the SCG.

The determining unit 1304 is further configured to trigger the interface unit 1302 to send, to the second network device, the third message carrying a second release identifier. When the first message does not carry the link failure related identifier, the second release identifier includes the identifier of the user equipment. Or, when the first message carries the link failure related identifier, the second release identifier is determined according to the link failure related identifier.

When the first message carries the link failure related identifier, the second release identifier includes the identifier of the user equipment and the identifier of the cell when the link failure related identifier includes the identifier of the cell corresponding to the radio link on which the failure occurs. Or, when the link failure related identifier includes the identifier of the SCG where the cell corresponding to the radio link on which the failure occurs belongs, the second release identifier includes the identifier of the user equipment. Or, when the link failure related identifier includes the identifier of the TAG where the cell corresponding to the radio link on which the failure occurs belongs, the second release identifier includes the identifier of the user equipment and the identifier of the TAG, or includes the identifier of the user equipment and an identifier of a cell included in the TAG. Or, when the link failure related identifier includes the identifier of the bearer corresponding to the radio link on which the failure occurs, the second release identifier includes the identifier of the user equipment, or includes the identifier of the user equipment and an identifier of a bearer served by an SCG serving the bearer.

Further, the transceiver unit 1301 is further configured to: send a first configuration parameter to the user equipment, where the first configuration parameter includes one or more of the following parameters: a maximum quantity of random access preamble retransmissions, duration of a timer, and a maximum quantity of radio link control (RLC) uplink data retransmissions; and/or send a second configuration parameter to the second network device, where the second configuration parameter includes one or more of the following parameters: a maximum quantity of times of attempting to receive a random access request, a maximum quantity of physical downlink control channel (PDCCH) retransmissions, a maximum quantity of RLC downlink data retransmissions, a preset block error rate, and a preset bit error rate.

It should be noted that a receiving unit in this embodiment may be a receiver of the first network device. In addition, the receiving unit and the transceiver unit may also be integrated to form a transceiver of the first network device. The acquiring unit may be a separately disposed processor, or may be integrated in a processor of the first network device for implementation, or may be stored in a memory of the first network device in the form of program code, and a processor of the first network device invokes and executes the function of the foregoing acquiring unit. The implementation of the determining unit is the same as that of the acquiring unit, and the determining unit may be integrated with the acquiring unit, or may be separately implemented. The processor herein may be a central processing unit (CPU), or an application specific integrated circuit (ASIC), or one or more integrated circuits configured to implement this embodiment.

In this embodiment, when user equipment or a secondary base station detects that a radio link failure occurs between the UE and the secondary base station, the user equipment or the secondary base station reports a message to a master base station, so as to notify the master base station that a radio link failure occurs between the UE and the secondary base station, so that the master base station learns that the radio link failure occurs between the UE and the secondary base station, and therefore unnecessary operations such as reestablishment of an SRB and reactivation of security may be no longer performed. In addition, the master base station may also perform further processing on the radio link failure, for example, release a resource related to the secondary base station and/or the UE, so that the secondary base station reallocates a resource to the UE as soon as possible, thereby effectively shortening a time of user data interruption caused by the radio link failure and improving user experience for a user.

### Embodiment 8

Continuing to refer to FIG. 14, FIG. 14 is a schematic structural diagram of another embodiment of UE. As shown in FIG. 14, the UE includes a receiver 1401, a transmitter 1402, a memory 1403, and a processor 1404. The receiver 1401, the transmitter 1402, and the memory 1403 are all connected to the processor 1404, for example, may be connected through a bus. Certainly, the UE may further include general components such as an antenna, a baseband processing component, an intermediate radio frequency processing component, and an input/output apparatus, which is not limited in this embodiment.

The receiver 1401 and the transmitter 1402 may be integrated to form a transceiver.

The memory 1403 is configured to store executable program code, where the program code includes a computer operation instruction. The memory 1403 may include a high-speed RAM memory, or may further include a non-volatile memory, for example, at least one disk memory.

The processor 1404 may be a central processing unit (CPU), or an application specific integrated circuit (ASIC), or one or more integrated circuits configured to implement this embodiment.

The processor 1404 executes the program code stored in the memory 1403, so as to detect whether a failure occurs on a radio link established between the UE and a second network device, and send a first message to a first network device through the transmitter 1402 when it is detected that a failure occurs on the radio link established between the UE and the second network device, where the first message is used for indicating that a failure occurs on the radio link established between the user equipment and the second network device.

Specifically, a manner in which the processor 1404 detects whether a failure occurs on the radio link established between the UE and the second network device is the same as that in the description of the detecting unit 901 in Embodiment 1, Embodiment 2, and Embodiment 5 in the foregoing, and is no longer elaborated herein.

In addition, a parameter used when the processor 1404 detects whether a failure occurs on the radio link established between the UE and the second network device may be acquired from the first network device through the receiver 1401, or may be acquired from the second network device through the receiver 1401; and content of the parameter is the same as that in Embodiments 1, 2, and 5 in the foregoing, and is no longer elaborated herein.

Content of the first message is the same as that in Embodiments 1, 2, and 5 in the foregoing, and is no longer elaborated herein.

After the processor 1404 sends the first message to the first network device through the transmitter 1402, the processor 1404 may further receive, through the receiver 1401, an instruction message sent by the first network device, where the instruction message is used for instructing the UE to release a cell, a secondary cell group (SCG), a timing advance group (TAG) or a bearer; and the processor 1404 is further configured to release a cell, an SCG, a TAG or a bearer according to the instruction message.

A process in which the processor 1404 releases a cell, an SCG, a TAG or a bearer is the same as that in Embodiments 1, 2, and 5 in the foregoing, and is no longer elaborated herein.

In this embodiment, when user equipment detects that a radio link failure occurs between the user equipment and a secondary base station, the user equipment reports a message to a master base station, so as to notify the master base station that a radio link failure occurs between the UE and the secondary base station, so that the master base station learns that the radio link failure occurs between the UE and the secondary base station, and therefore unnecessary operations such as reestablishment of an SRB and reactivation of security may be no longer performed. In addition, the master base station may also perform further processing on the radio link failure, for example, release a resource related to the secondary base station and/or the UE, so that the secondary base station reallocates a resource to the UE as soon as possible, thereby effectively shortening a time of user data interruption caused by the radio link failure and improving user experience for a user.

### Embodiment 9

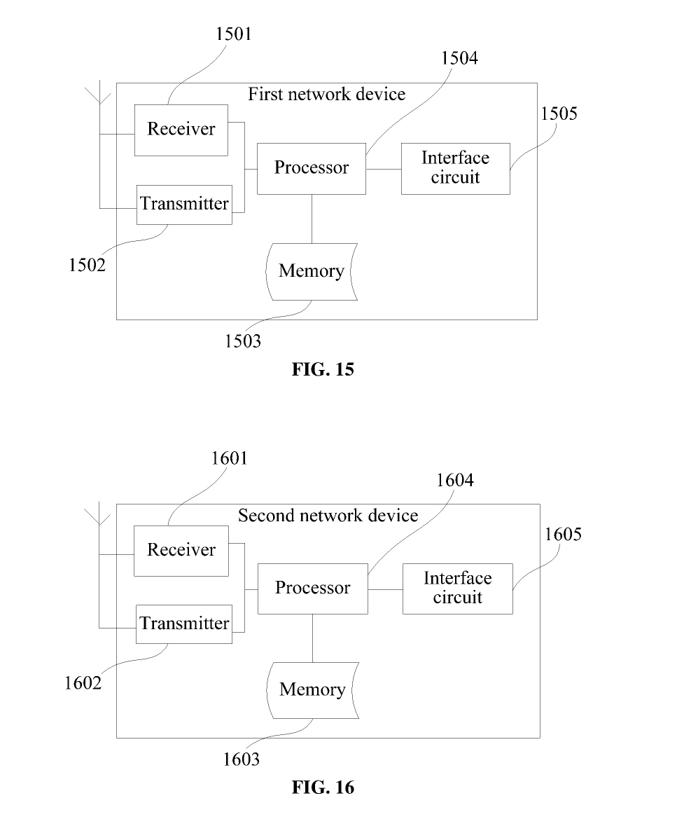

Continuing to refer to FIG. 15, FIG. 15 is a schematic structural diagram of another embodiment of a first network device. As shown in FIG. 15, the first network device includes a receiver 1501, a transmitter 1502, a memory 1503, an interface circuit 1505, and a processor 1504. The receiver 1501, the transmitter 1502, the interface circuit 1505, and the memory 1503 are all connected to the processor 1504, for example, may be connected through a bus. Certainly, the first network device may further include general components such as an antenna, a baseband processing component, an intermediate radio frequency processing component, and an input/output apparatus, which is not limited in this embodiment.

The receiver 1501 and the transmitter 1502 may be integrated to form a transceiver.

The memory 1503 is configured to store executable program code, where the program code includes a computer operation instruction. The memory 1503 may include a high-speed RAM memory, or may further include a non-volatile memory, for example, at least one disk memory.

The processor 1504 may be a central processing unit (CPU), or an application specific integrated circuit (ASIC), or one or more integrated circuits configured to implement this embodiment.

The interface circuit 1505 is configured to connect to another network device, and may be, for example, an optical fiber interface, so as to implement communication with a second network device through an optical fiber.

The processor 1504 is configured to obtain a first message from the second network device or UE through the interface circuit 1505 or the receiver 1501, where the first message is reported by the second network device or the UE to the first network device after the second network device or the UE detects that a failure occurs on a radio link established between the UE and the second network device. After obtaining the first message, the processor 1504 may determine that a failure occurs on the radio link established between the UE and the second network device.

Further, the processor 1504 may further perform subsequent processing on the failure. For example, the processor 1504 delivers instruction messages (a second message and a third message) to the UE and the second network device through the transmitter 1502 and the interface circuit 1505 respectively, so as to instruct the UE to release a cell, a secondary cell group (SCG), a timing advance group (TAG) or a bearer and instruct the second network device to release a resource used for serving the UE, respectively. Certainly, the processor 1504 may deliver the instruction message to only the UE or to only the second network device.

The description of the instruction messages (for example, the second message and the third message) is the same as that in the foregoing embodiment, and is no longer elaborated herein.

Content of the first message is the same as that in the foregoing embodiment, and is no longer elaborated herein.

In addition, the processor 1504 may further configure a parameter for the UE and the second network device to detect a link failure; for example, the processor 1504 may send a configuration parameter to the UE through the transmitter 1502, so that the UE detects whether a failure occurs on the radio link established between the UE and the second network device, and the configuration parameter is the same as that described in Embodiments 1, 2, and 5 in the foregoing, and is no longer elaborated herein. For another example, the processor 1504 may send a configuration parameter to the second network device through the interface circuit 1505, so that the second network device detects whether a failure occurs on the radio link established between the UE and the second network device. The configuration parameter is the same as that described in Embodiments 3, 4, and 6 in the foregoing, and is no longer elaborated herein.

In this embodiment, when user equipment or a secondary base station detects that a radio link failure occurs between the UE and the secondary base station, the user equipment or the secondary base station reports a message to a master base station, so as to notify the master base station that a radio link failure occurs between the UE and the secondary base station, so that the master base station learns that the radio link failure occurs between the UE and the secondary base station, and therefore unnecessary operations such as reestablishment of an SRB and reactivation of security may be no longer performed. In addition, the master base station may also perform further processing on the radio link failure, for example, release a resource related to the secondary base station and/or the UE, so that the secondary base station reallocates a resource to the UE as soon as possible, thereby effectively shortening a time of user data interruption caused by the radio link failure and improving user experience for a user.

### Embodiment 10

Continuing to refer to FIG. 16, FIG. 16 is a schematic structural diagram of another embodiment of a second network device. As shown in FIG. 16, the second network device includes a receiver 1601, a transmitter 1602, a memory 1603, an interface circuit 1605, and a processor 1604. The receiver 1601, the transmitter 1602, the interface circuit 1605, and the memory 1603 are all connected to the processor 1604, for example, may be connected through a bus. Certainly, the second network device may further include general components such as an antenna, a baseband processing component, an intermediate radio frequency processing component, and an input/output apparatus, which is not limited in this embodiment.

The receiver 1601 and the transmitter 1602 may be integrated to form a transceiver.

The memory 1603 is configured to store executable program code, where the program code includes a computer operation instruction. The memory 1603 may include a high-speed RAM memory, or may further include a non-volatile memory, for example, at least one disk memory.

The processor 1604 may be a central processing unit (CPU), an application specific integrated circuit (ASIC) or one or more integrated circuits configured to implement this embodiment.

The interface circuit 1605 is configured to connect to another network device, and may be, for example, an optical fiber interface, so as to implement communication with the second network device through an optical fiber.

The processor 1604 executes program code stored in the memory 1603, so as to detect whether a failure occurs on a radio link established between UE and the second network device, and sends a first message to a first network device through the interface circuit 1605 when it is detected that a failure occurs on the radio link established between the UE and the second network device, where the first message is used for indicating that a failure occurs on the radio link established between the user equipment and the second network device.

Specifically, a manner in which the processor 1604 detects whether a failure occurs on the radio link established between the UE and the second network device is the same as that in the description in Embodiment 3, Embodiment 4, and the description of the detecting unit 1101 in Embodiment 6 in the foregoing, and is no longer elaborated herein.

In addition, a parameter used when the processor 1604 detects whether a failure occurs on the radio link established between the UE and the second network device may be acquired from the first network device through the interface circuit 1605, or may be preset locally; and content of the parameter is the same as that in Embodiments 3, 4, and 6 in the foregoing, and is no longer elaborated herein.

Content of the first message is the same as that in Embodiments 3, 4, and 6 in the foregoing, and is no longer elaborated herein.

After the processor 1604 sends the first message to the first network device through the interface circuit 1605, the processor 1604 may further receive, through the interface circuit 1605, an instruction message sent by the first network device, where the instruction message is used for instructing release of a resource used for serving the UE. The processor 1604 is further configured to release, according to the instruction message, a resource used for serving the UE.

A process in which the processor 1604 releases the resource used for serving the UE is the same as that in Embodiments 3, 4, and 6 in the foregoing, and is no longer elaborated herein.

In this embodiment, when a secondary base station detects that a radio link failure occurs between the secondary base station and UE, the secondary base station reports a message to a master base station, so as to notify the master base station that a radio link failure occurs between the UE and the secondary base station, so that the master base station learns that the radio link failure occurs between the UE and the secondary base station, and therefore unnecessary operations such as reestablishment of an SRB and reactivation of security may be no longer performed. In addition, the master base station may also perform further processing on the radio link failure, for example, release a resource related to the secondary base station and/or the UE, so that the secondary base station reallocates a resource to the UE as soon as possible, thereby effectively shortening a time of user data interruption caused by the radio link failure and improving user experience for a user.

A person of ordinary skill in the art may understand that all or a part of the steps of the embodiments may be implemented by hardware or a program instructing related hardware. The program may be stored in a computer-readable storage medium. The storage medium may be a read-only memory, a magnetic disk or an optical disc.

The foregoing descriptions are merely exemplary embodiments, but are not intended to limit the present disclosure. Any modification, equivalent replacement, and improvement made within the spirit and principle of the present disclosure shall fall within the protection scope of the present disclosure.

What is claimed is:

1. A method, comprising:
detecting, by a user equipment, whether a failure occurs on a radio link established between the user equipment and a second network device; and
sending, by the user equipment, a first message to a first network device in response to a detection that a failure occurs on the radio link established between the user equipment and the second network device, wherein the first message is used for indicating that a failure occurs on the radio link established between the user equipment and the second network device.

2. The method according to claim 1, wherein the user equipment determines that a failure occurs on a radio link established between the user equipment and a second network device in response to at least one of:
a quantity of random access request retransmissions by the user equipment over a first radio link reaches or exceeds a maximum quantity of random access preamble retransmissions, wherein the first radio link is any radio link established between the user equipment and the second network device;
a timer corresponding to a first cell reaches or exceeds duration of the timer, wherein the first cell is any cell of the second network device; or
a quantity of radio link control (RLC) uplink data retransmissions by the user equipment over a first radio bearer reaches or exceeds a maximum quantity of RLC uplink data retransmissions, wherein the first radio bearer is any radio bearer over which the second network device serves the user equipment, and is borne on one or more radio links established between the user equipment and the second network device.

3. The method according to claim 2, further comprising receiving a configuration parameter, wherein the configuration parameter comprises at least one of the maximum quantity of random access preamble retransmissions; the duration of the timer; or the maximum quantity of RLC uplink data retransmissions.

4. The method according to claim 1, wherein the first message carries a link failure related identifier, and the link failure related identifier comprises at least one of an identifier of a cell corresponding to the radio link on which the failure occurs; an identifier of a secondary cell group (SCG) where a cell corresponding to the radio link on which the failure occurs belongs; an identifier of a timing advance group (TAG) where a cell corresponding to the radio link on which the failure occurs belongs; or an identifier of a bearer corresponding to the radio link on which the failure occurs.

5. The method according to claim 1, wherein the first message carries a link failure cause.

6. The method according to claim 5, wherein the link failure cause comprises at least one of a random access problem; a quantity of random access preamble retransmissions reaching or exceeding a maximum quantity of random access preamble retransmissions; a quantity of RLC uplink data retransmissions reaching or exceeding a maximum quantity of RLC uplink data retransmissions; expiration of a timer; or a reconfiguration failure.

7. The method according to claim 1, further comprising:
receiving an instruction message sent by the first network device, wherein the instruction message is used for instructing the user equipment to release a cell, a secondary cell group (SCG), a timing advance group (TAG), or a bearer; and
releasing a cell, an SCG, a TAG, or a bearer according to the instruction message.

8. A method, comprising:
receiving, by a first network device, a first message, wherein the first message is reported to the first network device by a user equipment or a second network device when a failure occurs on a radio link established between the user equipment and the second network device; and
determining, by the first network device according to the first message, that a failure occurs on the radio link established between the user equipment and the second network device.

9. The method according to claim 8, wherein the first message carries a link failure related identifier, and the link failure related identifier comprises at least one of an identifier of a cell corresponding to the radio link on which the failure occurs; an identifier of a secondary cell group (SCG) where a cell corresponding to the radio link on which the failure occurs belongs; an identifier of a timing advance group (TAG) where a cell corresponding to the radio link on which the failure occurs belongs; or an identifier of a bearer corresponding to the radio link on which the failure occurs.

10. The method according to claim 8, wherein the first message carries a link failure cause.

11. The method according to claim 8, further comprising sending a first configuration parameter to the user equipment, wherein the first configuration parameter comprises at least one of a maximum quantity of random access preamble retransmissions; duration of a timer; or a maximum quantity of radio link control (RLC) uplink data retransmissions.

12. A device, located on a user equipment side, comprising:
a processor; and
a computer-readable storage medium storing a program to be executed by the processor, the program including instructions for:
detecting whether a failure occurs on a radio link established between user equipment and a second network device; and
sending a first message to a first network device when it is detected that a failure occurs on the radio link established between the user equipment and the second network device, wherein the first message is used for indicating that a failure occurs on the radio link established between the user equipment and the second network device.

13. The device according to claim 12, wherein it is determined that a failure occurs on a radio link established between the user equipment and a second network device in response to a detection of at least one of:
a quantity of random access request retransmissions by the user equipment over a first radio link reaches or exceeds a maximum quantity of random access preamble retransmissions, wherein the first radio link is any radio link established between the user equipment and the second network device;
a timer corresponding to a first cell reaches or exceeds duration of the timer, wherein the first cell is any cell of the second network device; or
a quantity of radio link control (RLC) uplink data retransmissions by the user equipment over a first radio bearer reaches or exceeds a maximum quantity of RLC uplink data retransmissions, wherein the first radio bearer is any radio bearer over which the second network device serves the user equipment, and is borne on one or more radio links established between the user equipment and the second network device.

14. The device according to claim 13, wherein the program further includes instructions for:
receiving a configuration parameter, wherein the configuration parameter comprises at least one of the maximum quantity of random access preamble retransmissions; the duration of the timer; or the maximum quantity of RLC uplink data retransmissions.

15. The device according to claim 12, wherein the first message carries a link failure related identifier, and the link failure related identifier comprises at least one of an identifier of a cell corresponding to the radio link on which the failure occurs; an identifier of a secondary cell group (SCG) where a cell corresponding to the radio link on which the failure occurs belongs; an identifier of a timing advance group (TAG) where a cell corresponding to the radio link on which the failure occurs belongs; or an identifier of a bearer corresponding to the radio link on which the failure occurs.

16. The device according to claim 12, wherein the first message carries a link failure cause.

17. The device according to claim 16, wherein the link failure cause comprises at least one of a random access problem; a quantity of random access preamble retransmissions reaching or exceeding a maximum quantity of random access preamble retransmissions; a quantity of RLC uplink data retransmissions reaching or exceeding a maximum quantity of RLC uplink data retransmissions; expiration of a timer; or a reconfiguration failure.

18. The device according to claim 12, wherein the program further includes instructions for:
receiving an instruction message sent by the first network device, wherein the instruction message is used for instructing the user equipment to release a cell, a secondary cell group (SCG), a timing advance group (TAG), or a bearer; and
releasing a cell, an SCG, a TAG, or a bearer according to the instruction message.

19. A device, located on a first network device side, comprising:
a transceiver configured to communicate with user equipment;
an interface configured to communicate with a second network device; and
a processor, configured to:
acquire a first message from the user equipment through the transceiver or from the second network device through the interface, wherein the first message is reported to a first network device by the user equipment or the second network device in response to a failure occurring on a radio link established between the user equipment and the second network device; and
determine, according to the first message, that a failure occurs on the radio link established between the user equipment and the second network device.

20. The device according to claim 19, wherein the first message carries a link failure related identifier, and the link failure related identifier comprises at least one of an identifier of a cell corresponding to the radio link on which the failure occurs; an identifier of a secondary cell group (SCG) where a cell corresponding to the radio link on which the failure occurs belongs; an identifier of a timing advance group (TAG) where a cell corresponding to the radio link on which the failure occurs belongs; or an identifier of a bearer corresponding to the radio link on which the failure occurs.

21. The device according to claim 20, wherein the first message further carries an identifier of the user equipment.

22. The device according to claim 19, wherein the first message carries a link failure cause.

23. The device according to claim 22, wherein the link failure cause comprises at least one of a random access problem; a quantity of random access preamble retransmissions reaching or exceeding a maximum quantity of random access preamble retransmissions; a quantity of RLC uplink data retransmissions reaching or exceeding a maximum quantity of RLC uplink data retransmissions; expiration of a timer; a reconfiguration failure; a quantity of times of receiving a random access request reaching or exceeding a maximum quantity of times of attempting to receive a random access request; a quantity of PDCCH retransmissions reaching or exceeding a maximum quantity of PDCCH retransmissions; a quantity of RLC downlink data retransmissions reaching or exceeding a maximum quantity of RLC downlink data retransmissions; a block error rate of uplink data reaching or exceeding a preset block error rate; a bit error rate of uplink data reaching or exceeding a preset bit error rate; an uplink reception problem; or a downlink sending problem.

24. The device according to claim 19, wherein the processor is further configured to:
trigger the transceiver to send a second message to the user equipment, wherein the second message is used for instructing the user equipment to release a cell, a secondary cell group (SCG), a timing advance group (TAG) or a bearer.

25. The device according to claim 19, wherein the processor is further configured to:
trigger the interface to send a third message to the second network device, wherein the third message is used for instructing the second network device to release a resource used for serving the user equipment.

26. The device according to claim 19, wherein the transceiver is further configured to:
send a first configuration parameter to the user equipment, wherein the first configuration parameter comprises one or more of the following parameters: a maximum quantity of random access preamble retransmissions, duration of a timer, and a maximum quantity of radio link control (RLC) uplink data retransmissions.
